(19) United States
(12) Patent Application Publication
(10) Pub. No.: US 2010/0272102 A1
(43) Pub. Date: Oct. 28, 2010

(54) SYSTEM AND METHOD FOR PACKET MESSAGING AND SYNCHRONIZATION

(75) Inventor: Osamu KOBAYASHI, Los Altos, CA (US)

Correspondence Address: STMICROELECTRONICS, INC., MAIL STATION 2346 , 1310 ELECTRONICS DRIVE, CARROLLTON, TX, 75006, US

(73) Assignee: STMICROELECTRONICS, INC., Carrollton, TX (US)

(21) Appl. No.: 12/765,760

(22) Filed: Apr. 22, 2010

Related U.S. Application Data
(60) Provisional application No. 61/172,165, filed on Apr. 23, 2009.
(60) Provisional application No. 61/177,973, filed on May 13, 2009.
(60) Provisional application No. 61/177,978, filed on May 13, 2009.
(60) Provisional application No. 61/173,081, filed on Apr. 27, 2009.
(60) Provisional application No. 61/177,968, filed on May 13, 2009.

(51) Int. Cl. H04L 12/56

(52) U.S. Cl. 370/389

(57) ABSTRACT

System and method for packet messaging and synchronization through a packet based display interface includes using a multiple packet transport protocols, translating packet messages between protocols and achieving time code synchronization with a packet protocol between multiple devices in a multimedia network. A packet based display interface includes a dual data transport module to communicate packet messages using first and second packet transport protocols across a bidirectional link and a media transport module to communicate video packets across a unidirectional link. A method for communicating packet messages between source and slave devices in a multimedia network includes translating messages between different packet transport protocols. An apparatus for synchronizing a sink device to a source device includes a counter module configured to be adjusted based on a received source global time code value and a transport module to transmit a sink global time code value to the source device.

### CROSS-REFERENCE TO RELATED APPLICATIONS

This patent application claims the benefit of priority under 35 U.S.C. 119(e) to (i) U.S. Provisional Patent Application Ser. No. 61/172,165 filed on Apr. 23, 2009 entitled “DISPLAY PORT USB” by Kobayashi, (ii) U.S. Provisional Patent Application Ser. No. 61/177,973 filed on May 13, 2009 entitled “DUAL MODE SIDEBAND PROTOCOL”, (iii) U.S. Provisional Patent Application Ser. No. 61/177,978 filed on May 13, 2009 entitled “SIDEBAND MESSAGING METHOD” by Kobayashi, (iv) U.S. Provisional Patent Application Ser. No. 61/173,081 filed on Apr. 27, 2009 entitled “AUDIO CHANNEL SYNCHRONIZATION” by Kobayashi and (v) U.S. Provisional Patent Application Ser. No. 61/177,968 filed on May 13, 2009 entitled “TIME CODE SYNCHRONIZATION METHOD”, all of which are hereby incorporated by reference herein for all purposes.

This patent application is also related to U.S. patent application Ser. No. 10/726,794 filed Dec. 2, 2003 and entitled “PACKET BASED VIDEO DISPLAY INTERFACE AND METHODS OF USE THEREOF,” U.S. patent application Ser. No. 12/423,724 filed Apr. 14, 2009 and entitled “SYSTEM AND METHOD FOR ENABLING TOPOLOGY MAPPING AND COMMUNICATION BETWEEN DEVICES IN A NETWORK,” and U.S. patent application Ser. No. 12/484,796 filed Jun. 15, 2009 and entitled “SYSTEM AND METHOD FOR DUAL MODE COMMUNICATION BETWEEN DEVICES IN A NETWORK,” all of which are hereby incorporated by reference herein for all purposes.

### TECHNICAL FIELD

The present invention relates generally to the communication networking of devices using packet messaging protocols in multimedia networks. More particularly, methods, software, hardware, and systems are described for using a packet messaging protocol, including a USB protocol together with a second packet protocol, and for time code synchronization through the packet messaging protocol between multiple devices in a multimedia network.

### BACKGROUND OF THE INVENTION

Advances in multimedia components and increased sophistication in network architectures and device capabilities has made for an increasing need to support a wide range of networking communication capabilities in multimedia devices. Many multimedia devices presently include separate media dependent interfaces, such as for video or audio, and data interfaces, such as for control or data. Multiple interfaces on each device can require multiple cables to connect two devices that have both media and data capabilities. While media dependent interfaces have historically been based on analog communication methods (VGA, Component Video), more recently digital communication methods (DVI, HDMI) have advanced to offer higher quality and greater flexibility in connecting a multimedia source device with a multimedia reproduction device. These interfaces have focused on upgrading the media dependent link but have only offered limited (if any) capability for data traffic. Thus many multimedia devices currently offer separate interfaces for high rate media and for high rate data, necessitating at least two different cables between a source device and a display device. For example many computer displays now include data interfaces such as USB ports that connect to a personal computer through a USB cable that is physically separate from a digital video cable that also connects between the display and the personal computer. Multimedia devices continue to include separate interface connectors for communicating video and high rate data on separate cables between a source device and a display device. Thus there exists a need for a digital communication interface that can support both high speed video and data transmission on a single interface connector and cable between devices in a multimedia network.

### SUMMARY OF THE INVENTION

This paper describes various embodiments that relate to systems and methods for communicating packet based messages between devices in a communication network.

In an embodiment, a packet based display interface configured to operate in a multimedia device in a network is described. The packet based display interface includes at least the following components. A media transport module is configured to communicate video packets across a first unidirectional link. A dual data transport module is configured to communicate packet messages, in transit to or from a first sideband message handler client service module, across a bidirectional link using a first packet transport protocol or a second packet transport protocol. A detection module is configured to receive an interrupt signal on a second unidirectional link opposite in direction to the first unidirectional link. An event monitor client service module is configured to determine the availability of a packet message from a second sideband message handler client service module across the bidirectional link based on the received interrupt signal. The first and second unidirectional links and the bidirectional link each use separate physical communication lines bundled together in a common cable.

In another embodiment, in a packet based display interface, a method for communicating a packet message between a master client service module in a source device and a slave device attached to a sink device is described. The source device and the sink device are connected through a bidirectional link in a multimedia network. The method includes at least the following steps. A first translation module in the sink device detects availability of a first packet message to communicate from the slave device attached to the sink device to the master device through the bidirectional link. In a first client service module in the sink device, a status indication is set, thereby indicating availability of the packet message. The status indication is transmitted from the first client service module to a second client service module in the source device in response to a status request from the second client service module. A second translation module in the source device sends a read request to the sink device in response to the transmitted status indication. The first translation module in the sink device translates the first packet message from a first packet transport protocol used by the slave device into a second packet message formatted using a second packet transport protocol. The sink device transmits the second packet message to the source device across the bidirectional link. The second translation module in the source device translates the received second packet message that uses the second packet transport protocol back into the first packet message that uses the first packet transport protocol. The translated first packet message is delivered to the master client service module in the source device.

In a further embodiment, a packet based display interface having an apparatus in a sink device for synchronizing the sink device to a source device in a multimedia network is described. The apparatus includes at least the following components. A local sink reference clock module is configured to generate a sink link clock signal. A unidirectional main link transport module is configured to receive multimedia packets at a symbol rate determined by the sink link clock signal. A counter module is configured to increment a value of a sink global time code register based on the sink link clock signal. A bidirectional auxiliary channel transport module is configured to receive a source global time code value from the source device and to transmit a subsequent sink global time code value to the source device. The value of the sink global time code register in the counter module is configured to be adjusted based on the received source global time code value.

### BRIEF DESCRIPTION OF THE DRAWINGS

The invention and the advantages thereof can best be understood by reference to the following description taken in conjunction with the accompanying drawings.

FIG. 1 illustrates an embodiment of a multimedia network of source, branch and sink devices connected by links in accordance with the principles of the invention.

FIG. 2 illustrates multiple packetized streams connecting through transceivers in multimedia devices to a multiple connection communication link between networked devices.

FIG. 3 illustrates an embodiment of communication processing modules within transceivers of networked devices connected through auxiliary channel links.

FIG. 4 illustrates a detailed embodiment of transceivers that communicate packetized data from auxiliary channel clients and packet data from a USB client across an auxiliary channel link between a source device and a sink device.

FIG. 5 illustrates a detailed embodiment of transceivers in a branch device connected to both a source device and a sink device and virtual channels supported between clients within the branch, source and sink devices across an auxiliary channel link.

FIG. 6 illustrates two distinct physical layer protocols and two distinct link layer protocols that form part of a dual transport communication module of a transceiver in a multimedia device.

FIG. 7 illustrates a source device containing a source transceiver and a USB host controller, with local USB devices attached, connected to a sink device containing a sink transceiver and a USB hub, with remote USB devices attached.

FIG. 8 illustrates a source device, a branch device and a sink device connected in series, each device connected to a USB device through a USB hub contained therein.

FIG. 9 summarizes an exemplary message format for an auxiliary client service and a USB client service that share an auxiliary channel using a set of control codes.

FIG. 10 illustrates a multimedia network connecting a source device to multiple sink devices through multiple branch devices including an intermediate hub device in accordance with an embodiment of the invention.

FIG. 11 illustrates relative port addressing used for messages between source devices, branch devices and sink devices.

FIG. 12 illustrates a syntax for sideband request and reply messages.

FIG. 13 illustrates a syntax for sideband packet messages and a syntax for USB client messages on a fast auxiliary channel.

FIG. 14 illustrates a message syntax for sideband packet messages on a “slow” auxiliary channel.

FIG. 15 illustrates updating relative port addresses for packet messages between a source device and a sink device through intermediate branch devices.

FIG. 16 illustrates a method for communicating a request packet message and receiving a reply packet message between a source device and a sink device through intermediate branch devices.

FIG. 17 illustrates a second method for communicating a request packet message and receiving a reply packet message between a sink device and a source device through intermediate branch devices.

FIG. 18 illustrates updating relative port addresses for packet messages from a source device to a sink device deferred by intermediate branch devices.

FIG. 19 illustrates an embodiment of a multimedia network of source, branch and sink devices connected by links in accordance with the principles of the invention.

FIG. 20 illustrates multiple packetized links connecting between transceivers in a simple network of multimedia devices.

FIG. 21 illustrates transport of a mixture of audio and video packets with associated time stamps through a unidirectional main link and data packets through a bidirectional link between a source device and sink device in a multimedia network.

FIG. 22 illustrates a prior art stream clock recovery method using timestamps between a source device and a sink device.

FIG. 23 illustrates a method for synchronizing a source device and a sink device using exchange of global time codes.

FIGS. 24, 25 and 26 illustrate additional details of the synchronization method of FIG. 23.

FIG. 27 illustrates an embodiment of an apparatus for global time code synchronization in a source device.

FIG. 28 illustrates an embodiment of an apparatus for global time code synchronization in a sink device.

FIG. 29 illustrates an embodiment of a multimedia network that adds a second source device to the multimedia network of FIG. 19.

### DETAILED DESCRIPTION OF EXAMPLE EMBODIMENTS

The present invention relates generally to the communication networking of devices using packet messaging protocols in multimedia networks. More particularly, methods, software, hardware, and systems are described for using a packet messaging protocol, including a USB protocol together with a second packet protocol, between multiple devices in a multimedia network.

In the following description, numerous specific details are set forth to provide a thorough understanding of the present invention. It will be apparent, however, to one skilled in the art that the present invention can be practiced without some or all of these specific details. In other instances, well known process steps have not been described in detail in order to avoid unnecessarily obscuring the present invention.

The following discussion provides descriptions of various embodiments well suited for providing a flexible communication link that supports simultaneous high speed data and video transmission. Multiple client services can each generate data streams having different transmission requirements. The multiple data streams can be transported through the communication link using more than one transport protocol, where each transport protocol can provide transmission characteristics that match well to the data's transmission requirements. Devices in a multimedia network can adaptively use multiple protocols as a network configuration or network attached device requirements change. The communication link can provide capabilities for a complex network of devices that support both video and high speed data transfer while remaining backward compatible with existing cables and connectors.

The following description focuses on multimedia network embodiments and their modes of operation. Such networks can have one or more multimedia source devices (e.g. personal computers, multimedia servers) connected in a network to one or more sink devices (e.g. displays) through one, none or several branch devices (e.g. hubs). Typical source devices can include but are not limited to any suitable video, audio, and/or data source device including a desktop computer, portable computer, DVD player, Blu-ray player, music player, set-top box or video graphics card, among a myriad of other multimedia content transmitting devices. Typical sink devices can include but are not limited to video displays monitors, audio reproduction devices, multimedia processing systems and many other devices that can “consume” multimedia packets. Typical branch devices can include but are not limited to distribution multiplexers, repeaters, concentrators, hubs and routers that can distribute packetized streams of multimedia and/or data between a plurality of interfaces connected thereto. Each multimedia link between a source device and a sink device, or between a source device and a branch device, or between a branch device and a sink device can include multiple communication links some of which can carry unidirectional multimedia traffic (such as video or audio) and some of which can transport bidirectional data traffic (such as information or control). One example of a multimedia link is described in U.S. patent application Ser. No. 10/726,794 entitled “Packet Based Video Display Interface and Methods of Use Thereof”, which is incorporated by reference herein.

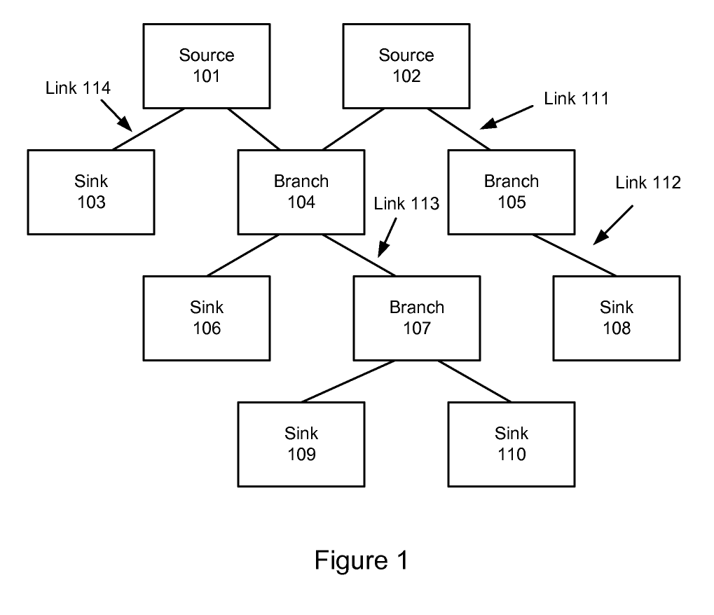

FIG. 1 illustrates an example network interconnecting two source devices to multiple sink devices either directly or through one or more branch devices. Suitable source devices can include any device that can “generate” and transmit a source signal and suitable sink devices can comprise any device that can receive and “consume” the source signal. A source device 101 that generates packetized multimedia and data traffic can be connected to a sink device 103 though a communication link 114 that supports multiple streams of multimedia and data packets. For example, the source device 101 (such as a DVD player) can generate a video stream that can be transported through the link 114 (such as a cable) to a sink device 103 (such as an LCD monitor) that can process and display the video stream. This video stream can be formatted as a series of packets transported in an isochronous stream with embedded self clocking (i.e. no separate clock signal). The stream of video packets can be transported using one or more unidirectional physical links. A separate bidirectional stream of data packets can accompany the unidirectional video stream on a separate physical link between the source device 101 and the sink device 103, both streams contained in the same cable.

With the increasing digitization of source media that includes video, audio and still photos among others, flexible multimedia source devices such as personal computers or multimedia servers can provide multiple independent high rate packetized data streams. Each packetized data stream can be routed to one or more of a plurality of sink devices through one or more branch devices within a multimedia network as illustrated in FIG. 1. Rather than transport the multiple packetized video and data streams through separate video and data communication links, such as a video VGA cable and a separate Ethernet or USB cable, an embodiment of the invention communicates packetized video streams and high rate data streams through an existing cable using a dual protocol interface. The interface described herein can provide capabilities for a more complex network of devices while remaining backward compatible with existing cables and connectors. In this way, the interface does not require adding new and separate physical connections to an existing interface, such as, for example, using previously unused pins in an existing connector (which can necessitate using a new cable).

A network capable source device can be connected indirectly to a sink device through one or more intermediate branch devices. For example, source device 102 can connect to sink device 108 through branch device 105 (via source to branch link 111 and branch to sink link 112); and source device 102 can also connect to sink device 110 though branch devices 104 and 107 (the latter connected together through link 113). Branch devices can offer various combining and separating functions for both unidirectional “media” streams and bidirectional “data” streams. For example a “splitter” branch device can divide a signal received on an input port among multiple output ports, while a “multiplexer” branch device can combine signals received on multiple input ports to a single output port. Other exemplary branch devices include replicators, concentrators, switches and hubs. It is also noted that the typical “generating”, “transferring” and “consuming” functions of source, branch and sink devices can be combined into a single hybrid device. For example a hybrid device can include a first sink device (a display) and internally a branch device (a hub) that enables connecting a second sink device (another display) or a third sink device (a storage device). Multiple branch devices can be interconnected to extend communication paths between a source device and a sink device, such as illustrated by source device 101 connected to sink device 110 through branch devices 104 and 107.

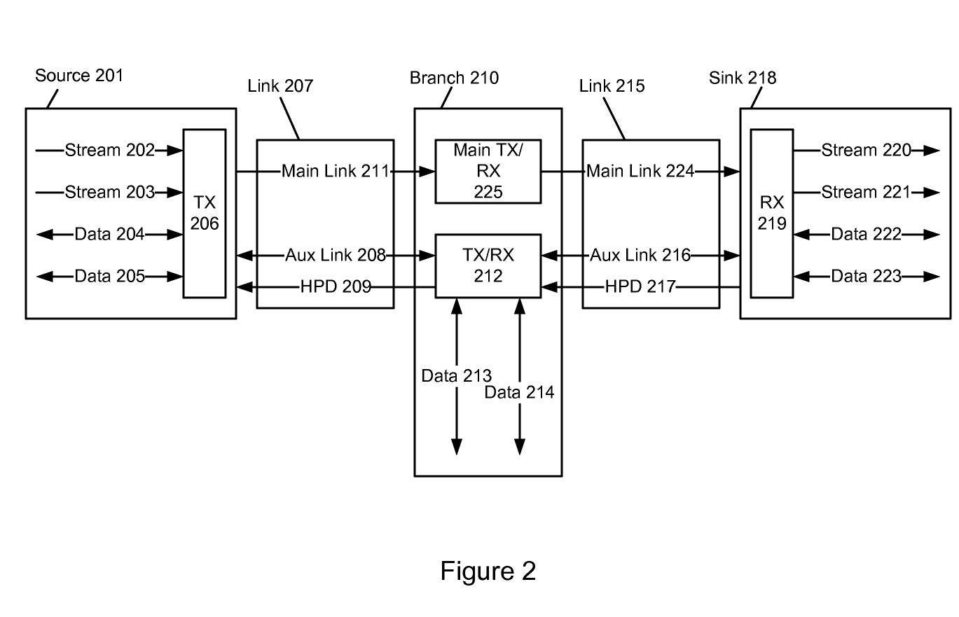

FIG. 2 illustrates selected elements of the source, branch and sink devices of FIG. 1 and of links interconnecting them. A source device 201 can include a plurality of multimedia streams 202 and 203 and data streams 204 and 205 connected to a link 207 through a “TX” transport module 206. While the label “TX” refers to the “transmitter” capability of the transport module 206 used for the unidirectional media streams 202 and 203, note that the transport module 206 also transmits and receives the bidirectional data streams 204 and 205, and thus includes elements of both a transmitter and a receiver, i.e. a transceiver. For clarity of discussion, we label the “transceivers” in the source, branch and sink devices as “TX”, “TX/RX” and “RX” respectively, but all of these “transceivers” include both transmit and receive functions for a bi-directional auxiliary link. The transport module 206 connects the source device 201 to a branch device 210 through a link 207 that includes a unidirectional main link 211 (in the source to branch direction), a bidirectional auxiliary link 208 and a hot plug detect (HPD) unidirectional link 209 (in the branch to source direction). The media streams 202 and 203 can be transported on the main link 211, while the data streams 204 and 205 can be transported on the auxiliary link 208. The main link 211 can provide high bandwidth, low latency communication using one or more physical communication channels. A main link TX/RX transport module 225 in the branch device 210 can receive the mail link 211 and repeat the mail link transmission as a main link 224 for further communication to the sink device 218.

The bidirectional auxiliary link 208 between the transport module 206 in the source device 201 and a “TX/RX” transport module 212 in the branch device 210 can be configured for half-duplex or full-duplex communication. Data packets in the data streams 204 and 205 in the source device 201 can be transported to and from the data streams 213 and 214 in the branch device 210 or communicated further to the sink device 218 through a second auxiliary link 216 contained in a second link 215. The TX/RX transport module 212 in the branch device 210 can thus the capability for multiplexing, splitting, concentrating, routing or switching data packets between a plurality of input ports and a plurality of output ports. The auxiliary link 208 can carry several types of packetized data messages between the source device 201 and other connected devices in the associated network.

The unidirectional HPD signal 209 from the branch device 210 to the source device 201 can be used to detect when an active branch device or active sink device couples to a network source device thus facilitating a robust “plug and play” capability. In some embodiments an HPD signal can be used as an interrupt request between devices. For example, in some embodiments a source device can serve as a master device for communication on a bidirectional auxiliary link with a sink device. Any transactions for data communication in either direction over the auxiliary channel can be initiated by the source device acting as a “master” controller, e.g. through a polling mechanism. In one approach, a branch device or a sink device can initiate communication to a source device in the network by sending an interrupt request through toggling the HPD signal line.

The branch device 210 illustrated in FIG. 2 does not contain an embedded sink device for the unidirectional multimedia streams and thus the main link 211 carrying the multimedia data can be connected directly to a second main link 224 in the second link 215 that terminates at a receiving “RX” transport module 219 in the sink device 218. The “RX” transport module 219 can separate the multimedia packets transported on the main link 224 into multiple streams 220 and 221. Similar to the “TX” transport module 206 in the source device 201, the “RX” transport module 219 in the sink device 218 can transmit and receive data streams 222 and 223 to and from the auxiliary link 216 that is contained in the second link 215 connected to the branch device 210. Packets in data streams 222 and 223 can be transported to/from data streams 213 and 214 in branch device 210 and to/from data streams 204 and 205 in source device 201.

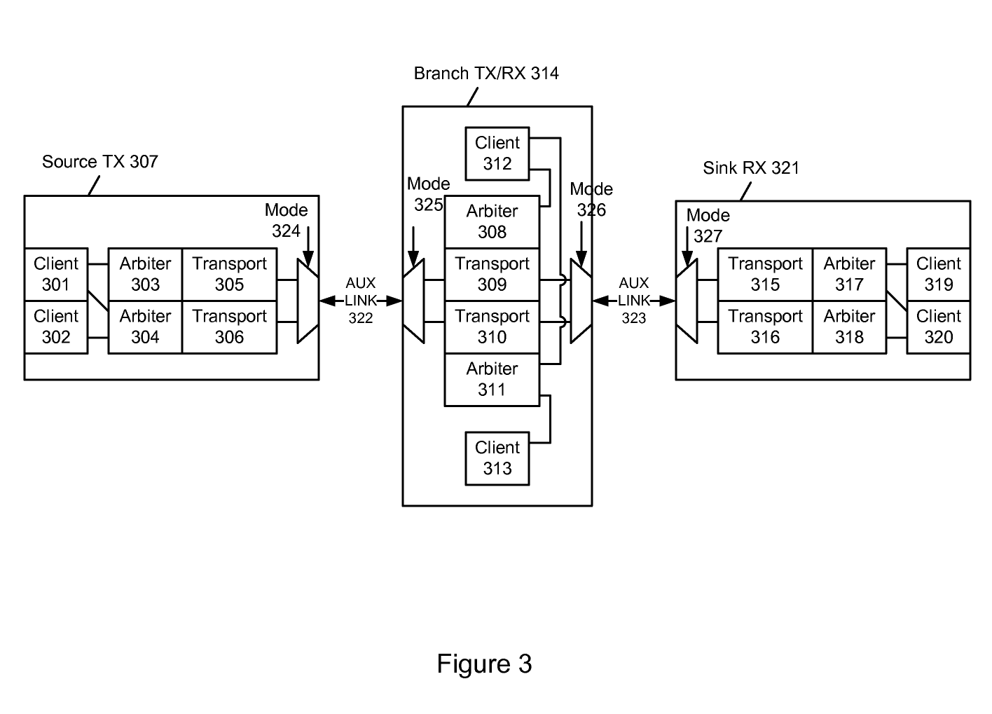

FIG. 3 illustrates a set of functional modules to implement dual mode transport within an interconnected network of source, branch and sink devices using bidirectional auxiliary links. A source transmit (TX) module 307, which corresponds to a portion of the transmit (TX) module 206 that communicates the data streams 204 and 205 in FIG. 2, can connect two distinct client services 301 and 302 to a bidirectional auxiliary link 322 using two different communication transport protocols through transport modules 305 and 306. Packetized data streams from both client service 301 and from client service 302 can be transported on the same auxiliary link 322 over the same physical communication channel but can use two different communication transport protocols. For example a transport module 305 can communicate packets from client 301 using a lower rate transport protocol, while transport module 306 can communicate packets from client 301 or client 302 using a different higher rate transport protocol. A mode switch 324 can determine which transport module connects to the auxiliary link 322 at any given time.

In the embodiment shown in FIG. 3, the client service 301 can use the higher rate transport protocol through transport module 306 or the lower rate transport protocol through transport module 305, while the client service 302 can only use the higher rate transport protocol through transport module 306. Different client services can require different properties from the transport protocol used. For example, data packets from the client service 301 can require only a low transfer data rate and thus can use either transport protocol, as both transport protocols can have sufficient throughput capability, while data packets from the client service 302 can require a higher transfer data rate and thus can use a higher rate transport protocol as offered by transport module 306. Other criteria can also differentiate which transport protocols can support different client services, such as reliability or guaranteed latency. In one embodiment the transport module 306 can offer a higher level of error protection when transporting data than a minimal limited error protection capability offered by transport module 305. In another embodiment, data packets communicated through the transport module 306 can incur a lower latency than data packets communicated through the transport module 305, which can influence a preferred transport protocol for each client service.

The sink receive (RX) module 321, which corresponds to a portion of the receive (RX) module 219 in the sink device 218 in FIG. 2, contains transport and client service modules analogous to those in the source transmit (TX) module 307. Client services 319 and 320 can communicate packets through transport modules 315 and 316, each using different transport protocols with different properties as described above for transport modules 305 and 306 in the source transmit (TX) module 307. Similarly the branch transmit/receive (TX/RX) module 314, which corresponds to a portion of the transmit/receive (TX/RX) module 212 for the branch device 210 in FIG. 2, contains two different transport modules 309 and 310 and a two separate client service modules 312 and 313. The transport modules 305, 309 and 315 can support one transport protocol with certain protocol properties, while the transport modules 306, 310 and 316 can support a second transport protocol with different protocol properties.

A mode switch at each end of an auxiliary link can determine which transport modules connect through the auxiliary link at any given time. For typical data transport both mode switches at each end of the auxiliary link, such as mode switches 324 and 325 connected to auxiliary link 322, can be set to connect analogous pairs of transport modules (e.g. 305/309 or 306/310) for continuous data transmission using one of the transport protocols. However in certain circumstances, such as during initialization of the auxiliary link or during mode switching initiated by one of the modules attached to one end of the auxiliary link, limited communication of messages transmitted using one transport protocol can be received by a transport module using a second transport protocol. For example, the mode switch 324 in the source TX module 307 and the mode switch 325 in the branch TX/RX module 314 can be set to use transport modules 306 and 310 respectively during normal “higher rate” packet data communication. The mode switch 324 in the source TX module 307 can then be changed to use transport module 305 based on a command from a higher level protocol module (not shown), such as when re-training a unidirectional main link (not shown) that accompanies the auxiliary link 322 in the same physical cable connecting the source and branch devices. The training method for the main link can require using the protocol supported by transport module 305 across the auxiliary link 322 rather than the protocol supported by transport module 306 used for high rate data transfer. If the mode switch 325 in the branch TX/RX module 314 is still set to use the transport module 310 after the mode switch 324 in the source TX module 307 changes, then messages received on the auxiliary link 322 from the source TX module 307 can use the transport protocol supported by transport module 309 rather than transport module 310. To accommodate this “mismatch” of transport protocols, the transport module 310 in the branch TX/RX module 314 can permit reception of a limited set of messages transmitted across the auxiliary link 322 using the transport protocol for transport modules 305/309. One such message can be a request to the branch TX/RX 314 module to switch to using the transport protocol of transport module 309 thereby changing the mode switch 325.

Each auxiliary link in a multimedia network of devices is a point-to-point link and can use its own transport protocol. Each of the auxiliary links in a network of devices can independently use different transport protocols from the other auxiliary links in the network during initialization, training and data transmission. For example auxiliary link 322 between source TX 307 and branch TX/RX 314 can use a higher rate transport protocol supported by transport modules 306 and 310, while auxiliary link 323 between branch TX/RX 314 and sink RX 321 can use a lower rate transport protocol supported by transport modules 309 and 315. Messages received by a branch device on a first auxiliary link using a lower rate transport protocol but destined for another device in the network using a higher rate transport protocol (for example a source device) can be “translated” before retransmission on a second auxiliary link. This translation can be accomplished in the transport modules 309 and 310 or within a higher layer client service module 312 that shares communication with both transport modules 309 and 310. In some embodiments, the source device can determine which transport protocol an attached sink device can use for the auxiliary link, even when connected through a number of intervening branch devices.

Each networked device that supports multiple client services and multiple transport protocols can include arbitration modules that manage the flow of messages between the client services and the transport modules. For example, source TX module 307 can contain an arbiter 304 that combines and distributes messages between client services 301 and 302 and the transport module 306. The arbiter 304 can ensure that neither client service 301 nor 302 dominates bandwidth for transmission through the transport module 306. Arbiters 303, 308, 311, 317 and 318 can provide similar functions for communication between client services and transport modules in their respective devices.

### USB Transport Over Auxiliary Channel

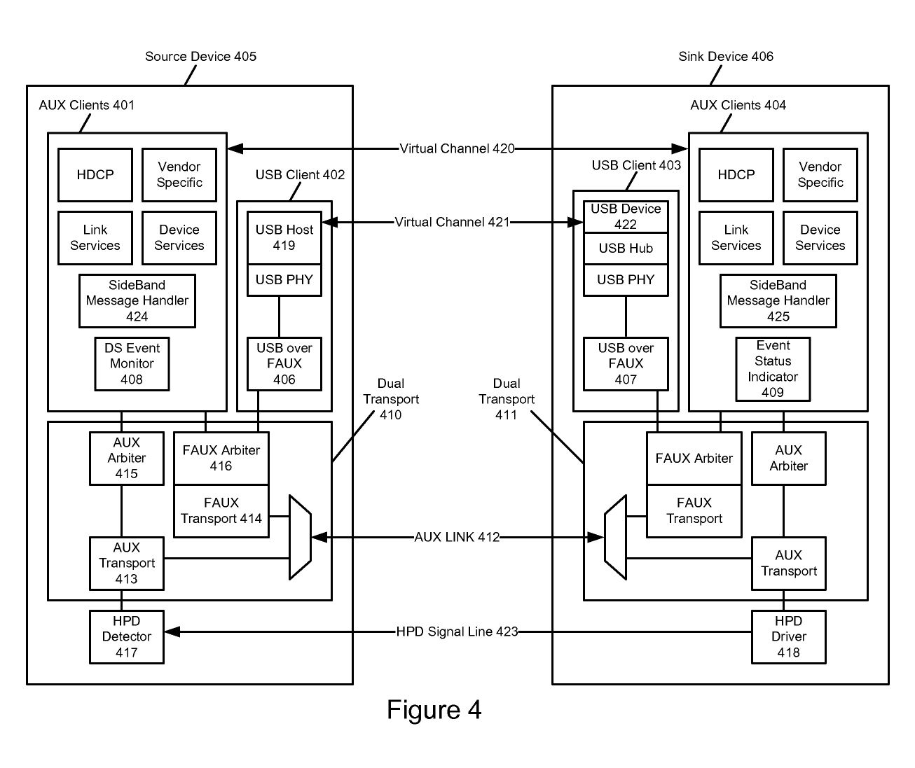

FIG. 4 illustrates an embodiment of a simple network connecting multiple client services between a source device 405 and a sink device 406 through a bidirectional auxiliary link 412 that supports two transport protocols. The client services in the source and sink devices can be considered “virtually” connected through a single physical communication channel auxiliary link. A unidirectional HPD signal line 423 also connects the two devices. The source device 405 can contain a plurality of client services (AUX clients 401) that can communicate to a plurality of client services (AUX clients 404) in the sink device 406 through either an AUX (auxiliary) transport module 413 that uses a first transport protocol or a FAUX (fast auxiliary) transport module 414 that uses a second transport protocol. In an embodiment, the AUX transport module 413 can use a lower rate transport protocol, while the FAUX transport module 414 can use a higher rate transport protocol. An arbitration module (AUX arbiter 415 when using AUX transport module 413 or FAUX arbiter 416 when using FAUX transport module 414) can combine messages from and distribute messages to multiple client services in the AUX clients module 401 communicated through the auxiliary link 412. A “high rate” client service (USB client service 402) can be transported through the FAUX transport module 414 but not through the AUX transport module 413, which can not support a high throughput required by the USB client service 402.

The dual transport module 410 in the source device and the dual transport module 411 in the sink device 406 “buffer” the client services from the specific transport protocols used on the auxiliary link 412. The client services need not know whether messages are transmitted using the AUX transport protocol or the FAUX transport protocol. An AUX client service in the source device 405 communicates through a “virtual” channel 420 to an AUX client service in the sink device 406. Similarly a USB client 402 in the source device 405 communicates through a “virtual” channel 421 to a USB client 403 in the sink device 406. As in a typical USB connection, a USB host 419 communicates with a USB device 422; however, rather than using a separate physical USB communication link using a USB specific transport protocol, USB data messages can be transported using the FAUX transport protocol over the bidirectional auxiliary link 412. The USB host 419 and USB device 422 need not know the specific transport protocol used by the dual transport modules 410 and 411 to communicate USB data packets through the auxiliary link 412.

The source device 405 can include a sideband message handler client service module 424 in the AUX client services module 401 that communicates packet messages across the virtual channel 420 with a sideband message handler client module 425 in the AUX client services module 404 in the sink device 406. The messages between sideband message handler client service modules 424/425 can be communicated using either a FAUX transport protocol or an AUX transport protocol, i.e. the sideband message handler client service modules 424/425 are transport protocol agnostic. The same sideband message packet can be transported within a single FAUX transport protocol's message packet or across several AUX transport protocol's message packets as will be illustrated later. Sideband message handler client service modules in each device can discover the capability for sideband message communication of other networked devices by reading and writing AUX link transactions to each other. Sideband messaging can occur across single AUX links between adjacent devices or through a series of several AUX links spanning two non-adjacent networked devices.

The sideband message handler client service modules 424/425 can work together with other client service modules to effect communication of packet messages between two networked devices. In one embodiment, a downstream event monitor client service module 408 in the source device 405 can indicate to the sideband message handler client service module 424 whether an interrupt signal is received by an HPD detector 417 on an HPD signal line 423 from an HPD driver 418 in the sink device 406. The interrupt signal can indicate that the sink device 406 has a packet message to send to the source device 405 through the AUX link 412. Alternatively, the interrupt signal can indicate that one or more of several different possible events has occurred at the sink device 406, and the downstream event monitor 408 in the source device 405 can read a status register from the sink device 406 to determine its current status. In one embodiment, the event status indicator client service module 409 in the sink device 406 can include a register with a status bit that can indicate that the sink device 406 has a sideband packet message to send to the source device 405. The DS event monitor client service module 408 in the source device 405 can read the register of the event status indicator client service module 409 in the sink device 406 in response to the interrupt signal received on the HPD signal line 423. Alternatively the source DS event monitor client service module 408 can poll the register for its contents independent of the interrupt signal on the HPD signal line 423. Thus the source device 405 can have two mechanisms, an interrupt signal and a status register, through which it determines the availability of a packet message for communication across the AUX link 412 from the sink device 406. In some embodiments one of the mechanisms can be used, while in other embodiments both mechanisms can be used together.

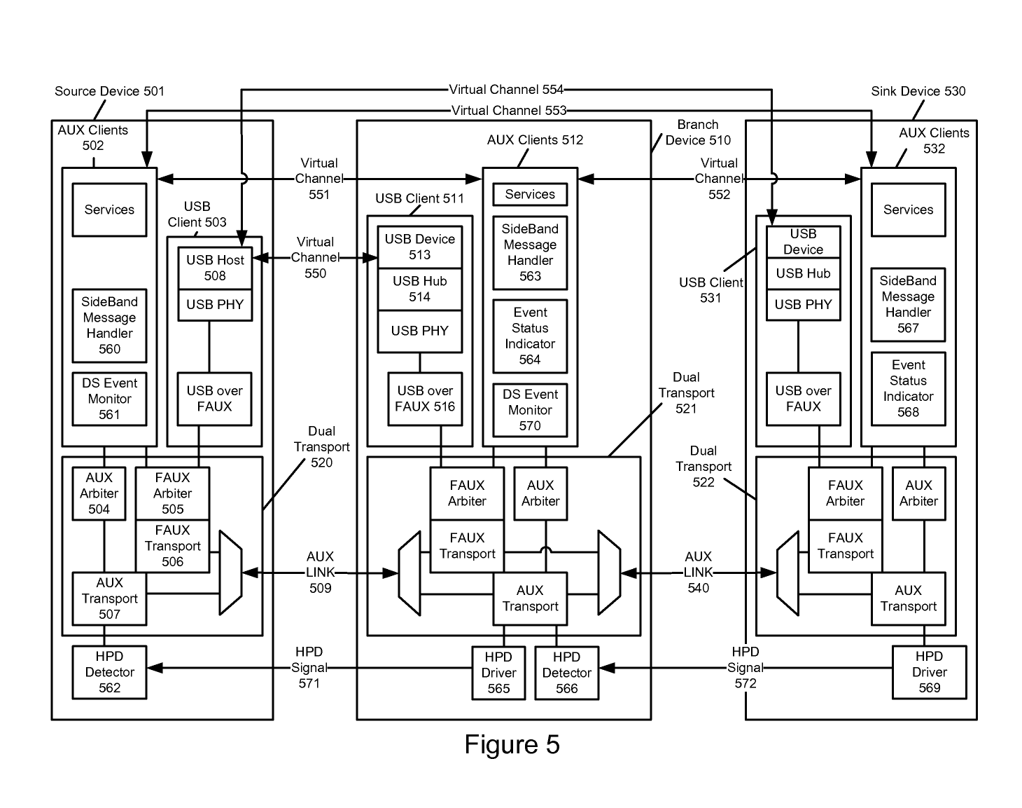

FIG. 5 illustrates a network connecting a source device 501 and a sink device 530 through a branch device 510. Auxiliary client services 502 in the source device 501 can communicate with auxiliary client services 512 in the branch device 510 through a virtual channel 551. Similarly auxiliary client services 532 in the sink device 530 can communicate with auxiliary client services 512 in the branch device 510 through a virtual channel 552. Auxiliary client services 502 in the source device 501 can also communicate with auxiliary client services 532 in the sink device 530 through a virtual channel 554 that spans an intermediate branch device 510.

A USB host 508 in a USB client service module 503 in the source device 501 can communicate with a USB device 513 in a USB client service module 511 in the branch device through a virtual channel 550 or can communicate with a USB device in the USB client 531 in the sink device 530 through virtual channel 553. The virtual channels 551 and 553 provide USB connections between the USB host 508 and two different USB client devices that can offer better performance than a typical “physical” USB connection. For example, the auxiliary links 509 and 540 that transport the USB traffic can extend to distances many times that required by a physical USB connection.

The branch device 510 can include both an event status indicator client service module 564, to indicate the availability of packet messages for communication to the source device 501, and a downstream event monitor client service module 570 to determine the availability of packet messages for communication from the sink device 530. The branch device 510 also can include both an HPD driver 565, to send an interrupt over an HPD signal line 571 to an HPD detector 562 in the source device 501, and an HPD detector 566 to receive an interrupt over an HPD signal line 572 from an HPD deriver 569 in the sink device 530. Note that the unidirectional HPD signal lines accompany a bidirectional AUX link, usually bundled together as separate physical connections in a common cable. The unidirectional HPD signal lines are point to point connections between adjacent devices in a network and do not traverse through a network to non-adjacent network devices.

Other embodiments can include additional client services to transfer data messages using the FAUX transport protocol through the auxiliary links. For example the USB client services 503, 511 and 531 can be supplemented by a parallel set of Ethernet client services connected similarly to the FAUX arbitration modules in the dual transport modules. As such, Ethernet data packets can be transported through an auxiliary link without adding additional physical communication lines to an existing cable or interface to support the Ethernet protocol. The FAUX arbiter modules can balance access to the FAUX transport module and AUX links between the USB client services and the Ethernet client services. Alternatively, Ethernet data packets from an Ethernet client service can be transported by embedding the Ethernet data packets within USB messages generated by a USB client service that uses the FAUX transport module over the AUX link, i.e. by communication between parallel client services before communication through the FAUX transport modules and over the AUX links.

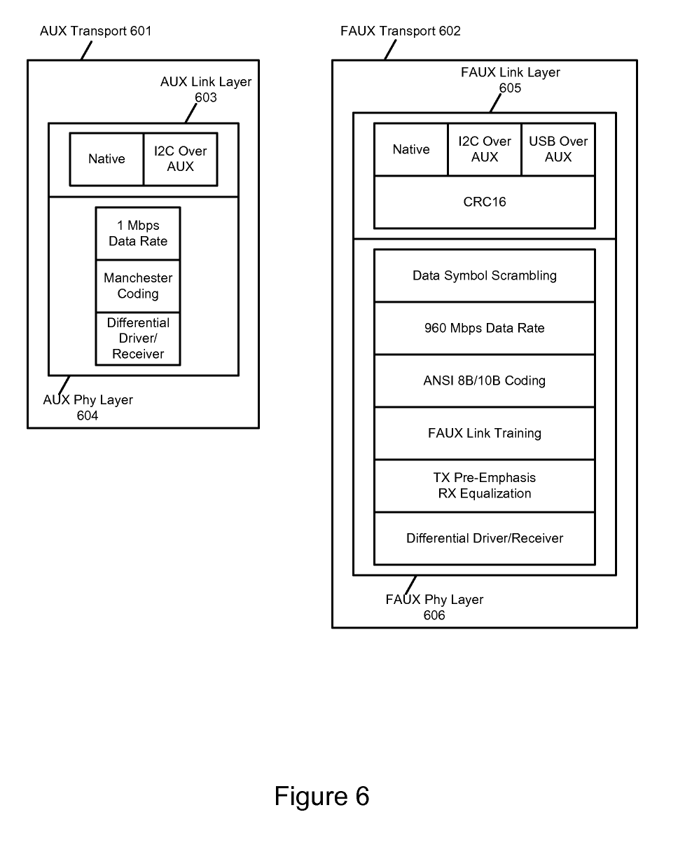

FIG. 6 summarizes properties of exemplary physical layer protocols and link layer protocols in the transport protocol modules of a dual transport module. An AUX transport module 601 can include an AUX physical layer 604 that connects an AUX link layer 603 with a physical communication line. The AUX physical layer 604 can use a differential driver and receiver to couple the device containing the AUX transport module 601 to the physical communication line. The AUX physical layer 604 can use Manchester encoding that supports a data rate of 1 Mbps and uses the encoded data stream directly for clock recovery, i.e. no separate clock signal required. A receiver using an AUX physical layer 604 can quickly adapt a phase lock loop because of frequent signal transitions in a received Manchester encoded signal. The AUX physical layer 604 primarily enables bit level transmission, and the AUX link layer 603 enables packet level transmission by grouping bits into formatted packets. Different link layer protocols can use different packet formats over the same physical layer transmission. For example the AUX link layer 603 can support one packet format (labeled “Native”) for data messages inherent to the AUX transport protocol on the auxiliary channel and a second packet format (labeled “I2C Over AUX”) for data messages that can carry messages originating from an “external” I2C bus to be transported over the auxiliary channel.

The FAUX transport module 602 can include a FAUX physical layer 606 that supports a higher data rate than the AUX physical layer 604 and a FAUX link layer 605 that can transport messages from an external high speed interface such as USB (shown) or Ethernet (not shown). The FAUX physical layer 606 can use the same differential driver and receiver as the AUX physical layer 604 to couple the devices to the physical auxiliary communication line; however, the FAUX physical layer can support a much higher data rate of 960 Mbps using ANSI 8B/10B encoding. Note that the signaling rate on the auxiliary communication line can be (10/8)*960 Mbps=1.2 Gbps to support the 960 Mbps data rate. Other signaling rates can be used on the auxiliary communication line for different data rates and encoding schemes. The FAUX physical layer 606 transmitter can use transmit pre-emphasis to shape the encoded signal for better transmission through the communication medium. The FAUX physical layer 606 receiver can use receive equalization to improve detection of the encoded signal after attenuation by the communication medium and in the presence of additive noise. The FAUX physical layer 606 can also use data symbol scrambling to ensure the encoded bit stream is randomized for improved transmission. Note that the ANSI 8B/10B encoding method assures a DC balanced stream of ones and zeroes with a maximum run length of 5 zeros, thus ensuring sufficiently frequent signal transitions to enable clock recovery using only the received data signal. As with the AUX physical layer 604, no separate clock signal is required by the FAUX physical layer 606.

The FAUX transport module 602 can include a FAUX link layer 605 that supports the same packet message formats used in the AUX link layer 603 (e.g. “Native” and “I2C Over Aux”) in addition to a third packet message format “USB Over Aux” used for data messages originating from an “external” USB host, hub or device. The FAUX link layer 605 can add a two byte cyclic redundancy check (CRC16) to each packet message for detection of transmission errors. Other link layer error correction methods can also be applied to permit both the detection and correction of errors in received packet messages. The FAUX link layer 605 can thus offer greater error protection than the AUX link layer 603, even when using the same “base” format for each packet message.

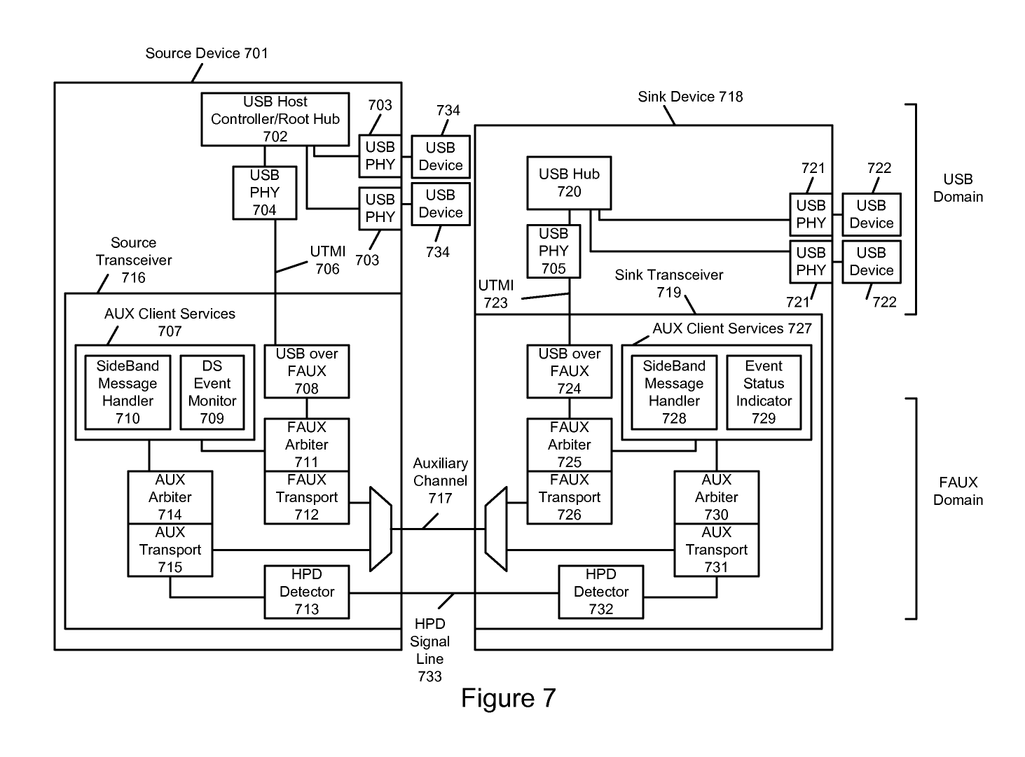

FIG. 7 illustrates a source device 701 connected to a sink device 718 through an auxiliary channel 717 and an HPD signal line 733, as in FIG. 4, augmented by USB devices attached to the source and sink devices. The source device 701 contains a source transceiver 716 that communicates with a sink transceiver 719 in the sink device 718. The bi-directional auxiliary channel 717 carries packetized traffic to and from auxiliary client services 707 (of which two are shown) and to and from a USB host controller 702 in the source device 701. The bi-directional auxiliary channel 717 also carries packetized traffic to and from auxiliary client services 727 and to and from a USB hub 720 in the sink device 718. The source transceiver 716 and the sink transceiver 719 serve to multiplex shared access to the auxiliary channel 717 for both USB client services and AUX client services, with enough bandwidth dynamically assigned to each service to ensure a desired throughput.

As described earlier, the auxiliary channel 717 can support multiple transport protocols, such as one transport protocol used by the AUX transport modules 715 and 731 and a second transport protocol used by the FAUX transport modules 712 and 726. In some embodiments, the FAUX transport protocol can support a substantially higher data throughput than the AUX transport protocol, and thus a source transceiver preferentially uses the FAUX transport protocol to communicate data packets from a USB client service that can require a high throughput rate. Rather than switch to using a lower rate AUX transport protocol for the AUX client services that can require a lower throughput rate, the source transceiver can also preferably use the FAUX transport protocol to communicate data packets between the AUX client services 707 and 727 in the source transceiver 716 and sink transceiver 719 respectively. Sharing the faster FAUX transport protocol between both slower AUX client services and faster USB client services can eliminate wasteful overhead that can be required to switch between AUX and FAUX protocols during data packet transmission.

The AUX transport protocol can be used for lower rate data transmissions in certain circumstances, such as when connecting a source device 701 to a sink device 718 that only supports the lower rate AUX transport protocol. Also the AUX transport protocol can be used during initialization of a connection between a source device 701 and any sink device 718 to ensure a common compatible protocol among all networked devices for basic communication. The source device 701 and the sink device 718 can use the faster FAUX transport protocol once they discover that each is capable of such a connection.

A FAUX arbiter module 711 in the source device 701 and a FAUX arbiter module 725 in the sink device 718 balance transmissions to and from AUX client services 707/727 and USB client services originating from the USB hubs 702/720 across the auxiliary channel 717. The AUX client services and the USB client services can use two different message formats for communication across the auxiliary channel thus enabling the FAUX arbiter modules 711/725 to determine easily to which service to deliver a received data packet. The FAUX arbiter modules 711/725 need not interpret an entire received data packet's message to determine where to deliver the data packet; instead, the FAUX arbiter modules 711/725 can use a field in the packet message that indicates whether the data packet is a USB messages or an AUX message.

In an embodiment, the USB host 702 communicates with remotely located (network attached) USB devices 722 using the same protocol as when communicating with locally attached USB devices 734. The USB host 702 and USB devices 722 can communicate without changes to software drivers, and the USB over FAUX modules 708 and 724 in the source device 701 and the sink device 718 appropriately form packet messages for communication across the auxiliary channel. The USB over FAUX modules 708/724 connect to co-located USB hubs through a well known USB interface, such as a USB 2.0 Transceiver Macrocell Interface (UTMI) 706/723. The USB over FAUX modules 708/724 ensure that the USB hubs and devices receive messages in a timely manner to maintain a high rate of communication, even across an auxiliary channel 717 on a cable that can extend longer than a cable length limit imposed by a USB protocol. A USB protocol can require a minimum roundtrip response time to each transmitted message, such as less than 1.5 us. To meet this USB protocol responsiveness requirement, separate USB domains can be maintained by the co-located USB over FAUX modules 708/724. Such methods are well known, and one exemplary method is described in U.S. Pat. No. 7,149,833 assigned to Icron Technologies Corporation. For example, for a USB “IN” request data message received by the USB over FAUX module 708 from the USB host 702, the USB over FAUX module 708 can respond to the USB host 702 with a NAK message if the requested data is not available to deliver to the USB host 702 within the roundtrip delay time required. The USB host 702 can send additional USB “IN” request data messages until the requested data is delivered by the USB over FAUX module 708. From the point of view of the USB host 702, the USB device is “busy” rather than “unresponsive.” The USB modules (USB host 702, USB Phy 703/704) in the source device 701 and the USB modules (USB Hub 720, USB Phy 705/721) in the sink device 702 communicate using USB packet transport protocols, while the source transceiver 716 and the sink transceiver 719 can communicate using a second, different transport protocol over the auxiliary channel 717. The USB over FAUX modules 708/724 can “translate” messages between respective USB and FAUX domains.

The standardized USB protocol uses a broadcast communication method in which a single “master” USB host controls communication between itself and multiple “slave” USB devices. Communication of packet data from a USB device to a USB host only occurs in response to an “IN” request data message sent from the USB host to the USB device. To ensure a high data transfer rate from a USB device to a USB host, each USB device can be polled regularly by the USB host to detect if the USB device has data to transfer. As the USB modules in FIG. 7 connect across the auxiliary channel 717 to form a “virtual” USB network, each USB device (including both local USB devices 734 and remote USB devices 722) can be polled in turn to permit fair access to the shared transmission medium. Rapid polling can be required to guarantee good throughput data transfer rates. As a remote USB device can be separated from the USB host by several intervening links, responsiveness and throughput can be improved by transferring data availability status from each remote USB device to the local USB over FAUX module 708 in the source transceiver 716 connected to the USB host 702 in the source device 701.

One exemplary method to communicate data availability status from a USB device 722 to a USB host 702 through an intervening auxiliary channel 717 can be implemented as follows. An event status indicator (ESI) module 729 in the sink transceiver 719 can maintain information about availability of USB data for transfer to the USB host 702 from the USB devices 722 locally connected to the sink device 718. The USB over FAUX module 724 in the sink device 718, in some embodiments, can transmit USB messages received from an upstream USB host 702 but cannot generate independently USB messages destined for the USB device 722. The USB over FAUX module 724 can communicate USB “IN” data request token packets, which are received from the USB host 702, through the UTMI interface 723 and the USB hub 720 to each attached USB device 722 at regular intervals, based on the USB host 702 regularly polling all USB devices in the network. The USB “IN” data request token packet delivery will result in a USB data transfer from the USB device 722 to the USB over FAUX module 724 if the USB device 722 has data available. The ESI module 729 in the sink transceiver 719 can then be updated based on USB data availability status obtained from the USB over FAUX module 724. In some embodiments the ESI module 729 can maintain a USB data availability status register indicating data has been received from an attached USB device 722. The downstream (DS) event monitor 709 in the source transceiver 716 can poll regularly the ESI module 729 in the sink transceiver to determine if USB data is available for transfer through the auxiliary channel 717. If the DS event monitor 709 in the source transceiver 716 determines that USB data is available for transfer then the USB over FAUX module 708 can send a “Read” request for USB data transfer from the USB over FAUX module 724 to the USB over FAUX module 708. This USB data transfer occurs in the FAUX domain, independently of messages between the USB host 702 and USB devices 722 in the USB domain. When the USB data is successfully transferred to the source transceiver 716, the USB over FAUX module 708 can then transfer the USB data to the USB host 702 when it next receives a USB “IN” data request token packet from the USB host 702.

This communication method decouples the transfer of USB packets between a USB host 702 and a USB device 722 into three separate links. A first transfer occurs between the USB device 722 and the USB over FAUX module 724 in the sink transceiver 719. After this first transfer, the USB device 722 can believe that the data has been successfully transferred to the USB host 702 when the USB over FAUX module 724 locally acknowledges to the USB device 722 the reception of the USB data by the USB over FAUX module 724, even though the data can be still in transit to the USB host 702. For the second transfer, the source transceiver 716 and sink transceiver 719 transport the USB data between each other based on availability indications provided by the Event Status Indicator 729 at the sink transceiver 719 polled by the Downstream Event Monitor 709 in the source transceiver 716. This data transfer across the auxiliary channel 717 occurs independently from communication in the USB domain. A third transfer occurs when the USB over FAUX module 708 responds to the USB host 702 polling for “In” data from the USB device 722.

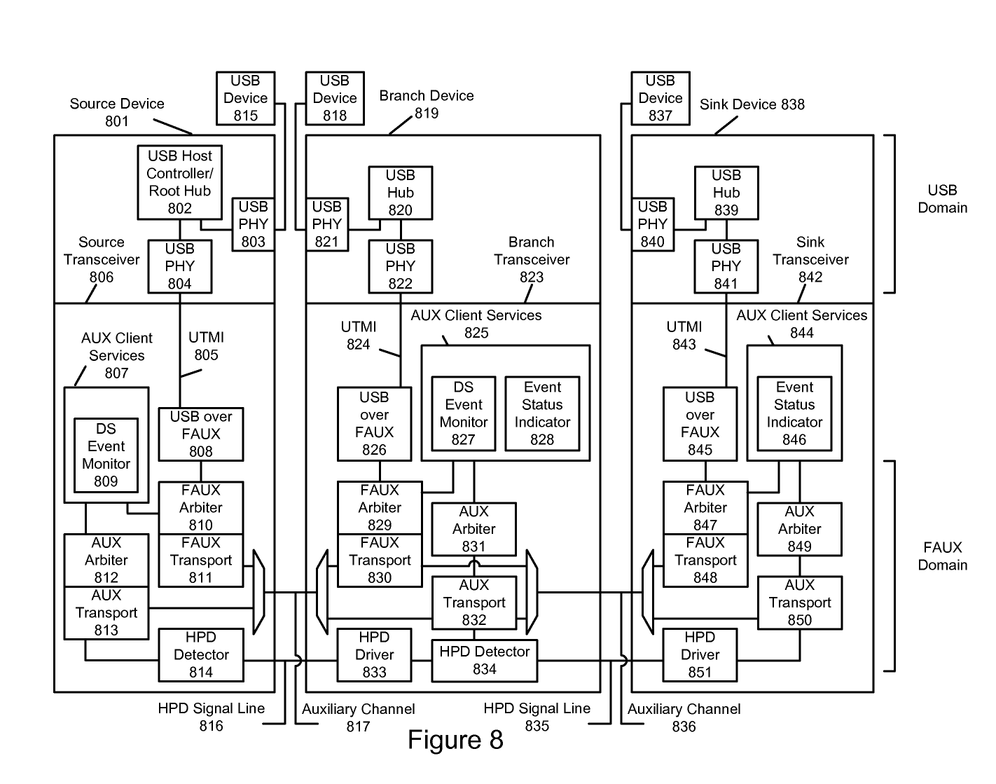

As illustrated in FIG. 1, a network of source devices 101/102 can be interconnected to multiple sink devices 103/106/109/109/110 through multiple branch devices 104/105/107. If each source device includes a USB host, then only one of the USB hosts can serve as a master USB host for the entire network to avoid a conflict of network control. Each of the branch and sink devices can have multiple USB devices connected to them, and the master USB host can communicate with each of the USB devices across a distributed network that extends the USB network “virtually” using auxiliary channels between host, branch and sink devices. FIG. 8 illustrates a simple network extension that adds a branch device 819 between a source device 801 and a sink device 838. The source device 801 includes a USB host controller 802 connected locally to a USB device 815 and remotely through an auxiliary channel 817 to a USB device 818 connected to the branch device 819. The USB host 802 is also connected remotely through a second auxiliary channel 836 to a USB device 837 attached to the sink device 838. As indicated in FIG. 8, the USB modules communicate in a “USB domain” using a standard USB messaging protocol, while the source, branch and sink transceivers communicate in a “FAUX domain” using a FAUX messaging protocol.

The transfer of data from the USB device 837 attached to the sink device 838 to the USB host 802 in the source device proceeds similarly to the data transfer described for FIG. 7, now over two intervening auxiliary channels 817/836. In response to an “IN” data request token packet received from the USB Host 802, the USB device 837 can transfer data to the USB over FAUX module 845 in the sink transceiver 842 through the USB hub 839. The sink transceiver 842 in the sink device 838 now has USB data to transfer upstream; however, the source transceiver 806 in the source device 801 has no knowledge yet of the USB data availability at the sink transceiver 842. Frequent status polling by each downstream event monitor in the AUX client services modules across each auxiliary channel in the network can ensure that USB data availability status reaches the source transceiver 806 rapidly. The Event Status Indicator module 846 in the sink transceiver 842 is changed to indicate the availability of USB data. The Downstream Event Monitor 827 in the branch transceiver 823 polls the ESI module 846 for the availability of USB data (as part of a regularly scheduling polling) and receives a USB data availability status update. The DS Event Monitor 827 in the branch transceiver 823 then updates the Event Status Indicator 828 to show the availability of USB data in the sink transceiver 842. Next the DS Event Monitor 809 in the source transceiver 806 polls the ESI module 828 in the branch transceiver 823 for the availability of USB data (again as part of a regularly scheduled polling). In some embodiments the polling by each node in a network can be offset from the polling by adjacent nodes to improve the rapidity with which USB data availability status propagates upstream from the sink devices and branch devices to the source device. When the DS Event Monitor 809 in the source transceiver 806 determines USB data availability at one of the branch devices or sink devices in the network, the USB over FAUX module 808 in the source transceiver 806 sends a “Read” request message to the USB over FAUX module in the appropriate branch or sink device. In this case the USB over FAUX module 808 sends a “Read” request to the USB over FAUX module 845 in the sink transceiver 842. This “Read” request FAUX message proceeds through the auxiliary channel 817 and the auxiliary channel 836 to the USB over FAUX module 845, which then transfers the USB data back upstream over the auxiliary channels 836/817 to the USB over FAUX module 808. The USB over FAUX module 808 in the source transceiver 806 then transfers the USB data to the USB host 802 when it next receives a USB “IN” data request token packet from the USB host 802.

The Event Status Indicator modules 828/846 can provide information on the availability of other events at a branch or sink device, such as the availability of messages for other AUX client services (not shown), interrupt flags or link status. Rapid polling of the Event Status Indicator modules can not only guarantee high throughput for USB data transfer in the upstream direction but also accelerate the transfer of these other messages and events from the branch and sink devices to the source device. As the source, branch and sink devices shown in FIGS. 7 and 8 support two transport protocols, a high speed FAUX protocol through the FAUX transport module 811 and a low speed AUX protocol through the AUX transport module, polling intervals by the DS event monitors can be adjusted for the speed of the transport protocol used. For example polling through the FAUX transport module can use an interval of 1 us (fast enough to support high speed USB traffic) while polling through the AUX transport module can use an interval of 2 ms (fast enough to support AUX client traffic). In some embodiments the polling could be reduced to “on demand” only, i.e. when an interrupt pulse is presented through the Hot Plug Detection (HPD) signal line. Increasing polling frequency can improve responsiveness; however, decreasing polling frequency can reduce the amount of throughput bandwidth overhead required for the polling. Thus it is preferred to set the polling frequency appropriately for the throughput rate.

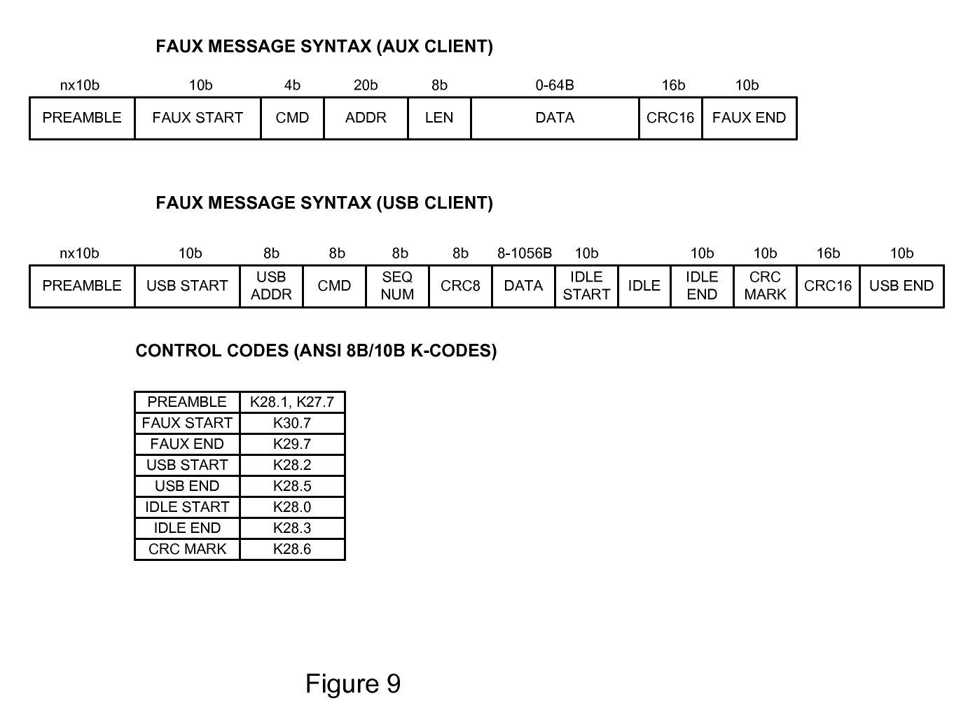

FIG. 9 illustrates a set of exemplary FAUX channel message formats for an AUX client and a USB client. As shown in FIG. 6, the FAUX physical layer protocol 606 in the FAUX transport protocol 602 can use ANSI 8B/10B coding. The FAUX message formats shown in FIG. 9 include 10-bit control codes (K-codes) that provide delineation markers within a FAUX message. Following a multi-bit preamble, either a FAUX START or a USB START control code begins the FAUX message. A FAUX arbiter module in a receiving device (such as FAUX arbiter 810 in FIG. 8) can direct a received FAUX message to either an AUX client service module or a USB over FAUX client service module based on this 10-bit control code without reading the rest of the received FAUX message. The FAUX message syntax can include a set of fields (CMD/ADDR/LEN/DATA), as can be used for AUX channel messages using an AUX transport protocol, followed by an additional error detection field CRC16 that provides an indication of the bit integrity of the received message. A FAUX END control code concludes the FAUX transport protocol's AUX client message.

The FAUX message format for a USB client can include a different initial 10-bit control code USB START after the multi-bit preamble and a different final 10-bit control code USB END. In between the USB START and USB end control codes a different message format can be used for the USB client messages. For example the FAUX transport protocol's USB client message can include an address USB ADDR to which to deliver the USB client message as well as several other control codes providing information specific to USB. Unlike the FAUX message format shown for the AUX client, the USB client FAUX message format can omit a length control code as shown. Thus an IDLE START and IDLE END control code can be inserted into the FAUX message to demark idle patterns from transmitted data. In addition a CRC MARK control code can directly precede and indicate a subsequent CRC16 error detection field that closes the message. Other possible message formats for the USB client between USB START and USB END control codes can be used that provide at least an address for delivery, data bytes and an error detection field. FIG. 9 includes a set of exemplary 10 bit control codes for the FAUX messages using the established ANSI 8B/10B control code format.

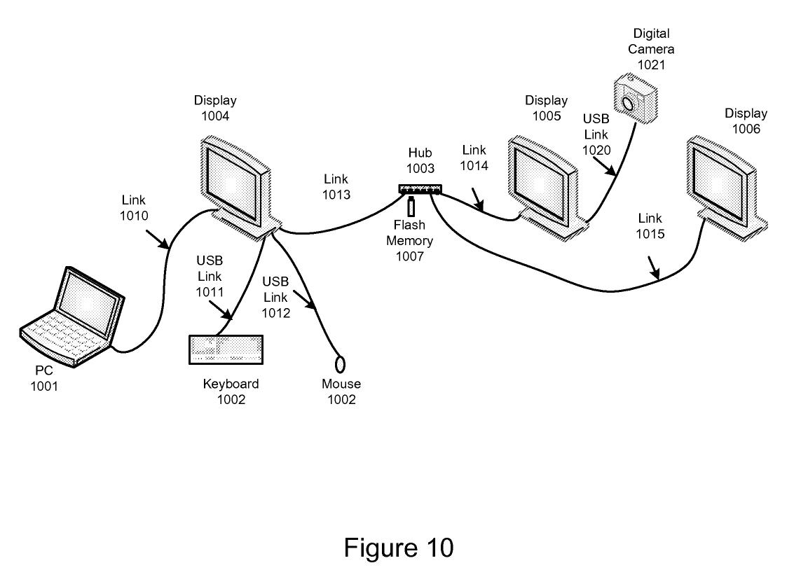

FIG. 10 illustrates a network in accordance with an embodiment of the invention. A laptop computer source device (PC 1001) can connect to a branch/sink device (Display 1004) through a link 1010 that includes a unidirectional packetized video main link and a bidirectional packetized auxiliary link. The packetized video on the main link can be displayed on the display 1004 and can also be re-transmitted further on a second link 1013. A USB keyboard sink device 1002 and a USB mouse device 1002 can connect to the branch/sink device (Display 1004) through a USB link 1011 and USB link 1012 respectively. The USB devices can communicate with the source device (PC 1001) through the dual transport capability of the auxiliary link contained in the link 1010. All or part of the information received on the link 1010 can be transmitted to a branch device (hub 1003) through the link 1013. Thus hub device can connect a USB device (flash memory 1007) to the source device (PC 1001) through the chain of link 1013 and link 1010. The hub device can also distribute video information and auxiliary channel information through link 1014 and link 1015 to sink devices (Displays 1005 and 1006) respectively. The sink device (Display 1005) can connect a USB device (digital camera 1021) via a USB link 1020 to the network for communication with the source device (PC 1001) through the three auxiliary links 1010, 1013 and 1014. FIG. 10 illustrates how a source/host device (PC 1001) can distribute a digital video stream to multiple displays and simultaneously communicate digital packet information with other peripheral devices (Keyboard 1002, Mouse 1002, Flash Memory 1007) using a single protocol over common cabling.

### Sideband Messaging

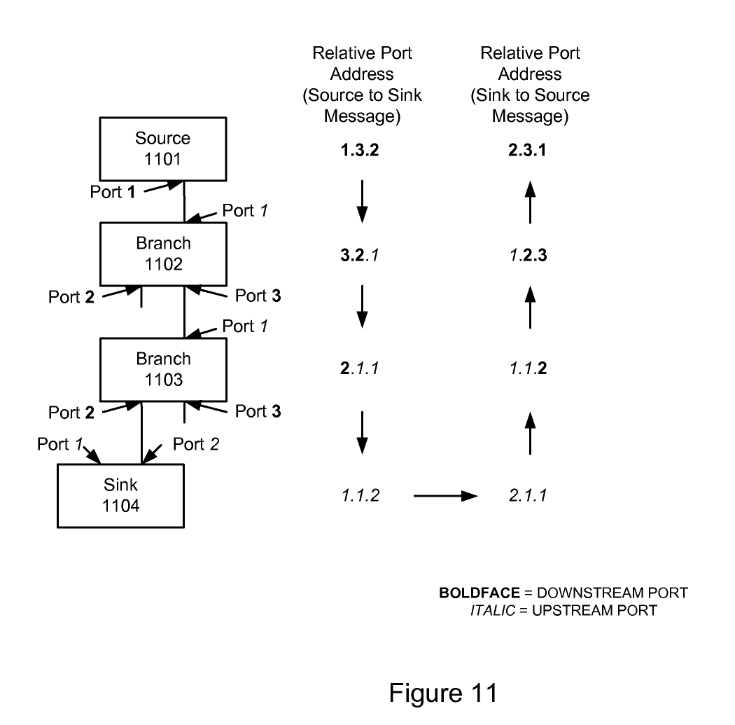

FIG. 11 illustrates a source device 1101 connected to a sink device 1104 through two intermediate branch devices 1102/1103 with individual ports of each device labeled by number. The port numbers can be used as part of a relative port address field for routing messages between networked devices as described in U.S. patent application Ser. No. 12/423,724 field Apr. 14, 2009 entitled “System and Method for Enabling Topology Mapping and Communication Between Devices in a Network” by the same inventor, assigned to the same assignee and incorporated by reference herein. A sideband message can include a relative port address that indicates the port number of the transmitting device and each intermediate device en route to the receiving device. The relative port address can be updated as the sideband message traverses the network between the transmitting and receiving devices to include the “forward” (toward the destination) device port addresses and the “reverse” (toward the origination) device port addresses.

FIG. 11 shows the relative port address of a sideband message as updated when a sideband message traverses from the source device 1101 to the sink device 1104. Initially the relative port address consists of three downstream ports in sequence, one port number for each network device starting with the source device 1101 and ending with the branch device 1103. (The relative port address does not include a “forward” port number for the destination sink device because the sink device does not forward the sideband message any further in the network.) Relative port addresses are “relative” to the current network device in which the sideband message resides. At the first branch device 1102, the relative port address is updated to delete the first “forward” downstream port (i.e. port 1 from the source device 1101 to the branch device 1102) and to add a “reverse” upstream port (i.e. port 1 from the branch device 1102 to the source device 1101). At the second branch device 1103, the relative port address is updated to delete the “forward” downstream port (i.e. port 3 from the branch device 1102 to the branch device 1103) and to add a “reverse” upstream port (i.e. port 1 from the branch device 1103 to branch device 1102). Finally at the sink device 1104, the relative port address is updated to a complete “reverse” address. Note that the relative port address updating deleted a port number at each stage from the leftmost position and added a port number to the rightmost position. As such “forward” routing information in a relative port address can be read left to right, while “reverse” routing information in a relative port address can be read right to left, where “forward” and “reverse” refers to the direction the message travels.

FIG. 11 also shows how relative port addresses update when a second message traverse from the sink device 1104 to the source device 1101 in response to the first message. At each intermediate branch device, the leftmost “forward” port number is deleted while a rightmost “reverse” port number is added. The initial “forward” relative port address can be derived from the previous “reverse” relative port address by reversing the order of the port numbers. Note that “forward” now refers to the upstream port numbers, while “reverse” references the downstream port numbers, as the message traverses the network from the sink device 1104 to the source device 1101. At each network device traversed, complete routing information toward the destination device and from the origination device is available in the relative port address.

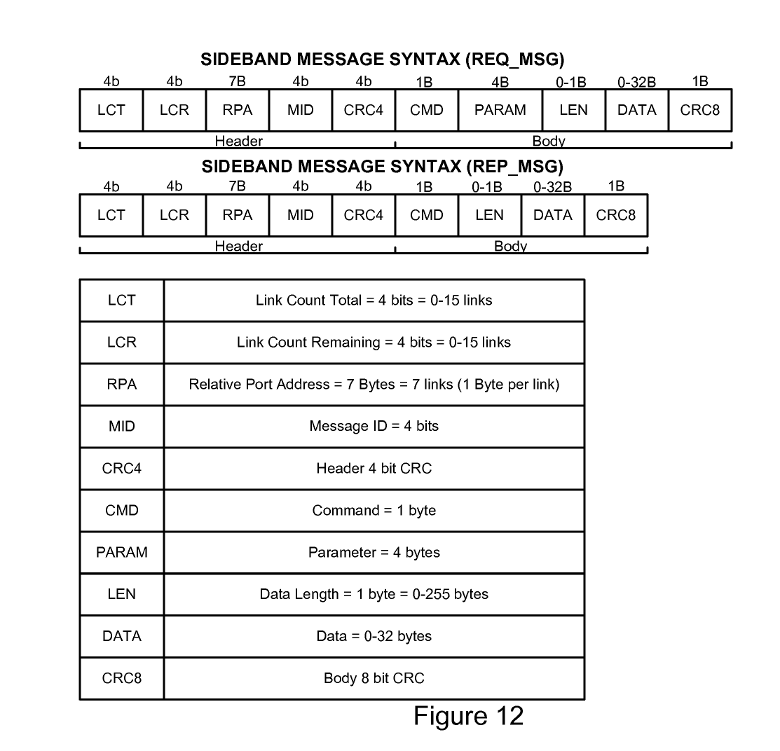

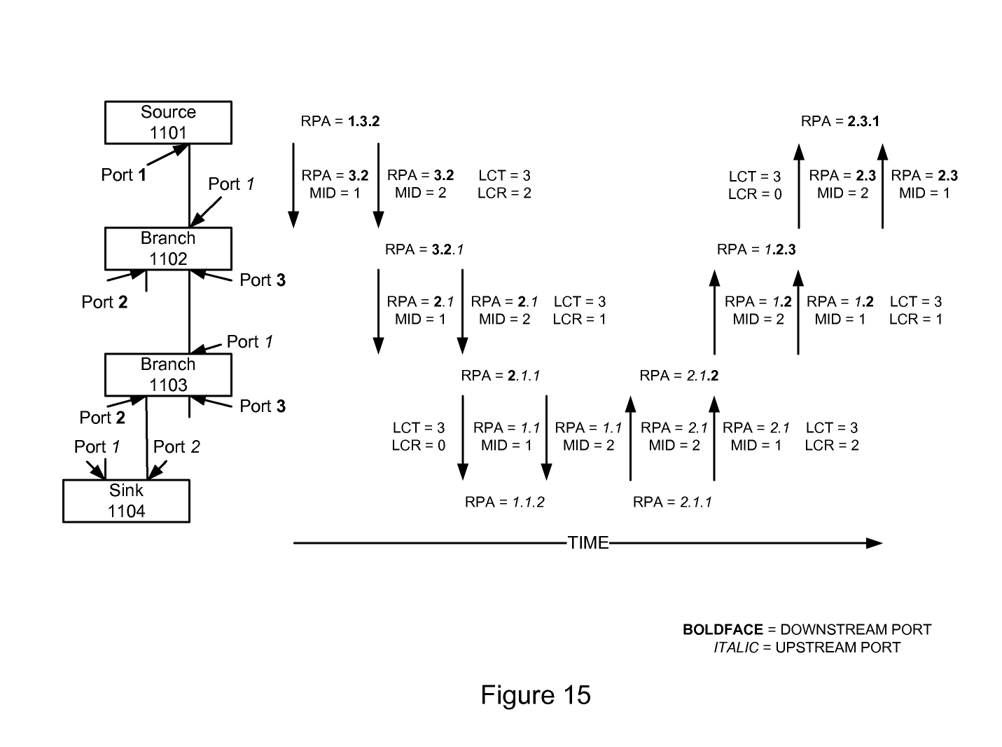

FIG. 12 illustrates a sideband message syntax that can be used for two distinct sideband messages, a request sideband message (REQ_MSG) and a reply sideband message (REP_MSG). Each sideband message uses the same header format beginning with a 4 bit link count total field and a 4 bit link count remaining field. The sideband message thus includes the total number of links that the sideband message will traverse from an origination device to a destination device, as well as the number of links remaining to traverse at an intermediate device until the sideband message will reach the destination device. While the four bit link count total can indicate up to 15 links, in a given network of devices a physical maximum limit on the number of links can be lower. The relative port address field, as illustrated, can use 7 bytes to list a maximum total of 7 physical links. As illustrated in FIG. 11, the relative port address can be updated as the sideband message traverses the network between the origination device and the destination device. The link count remaining can be decremented by one for each link traversed. As shown in FIG. 11 the relative port address includes a port number for each link. The relative port address of a sideband message can be updated before sending that message on the next link to remove the port number of the current device, thus lowering the number of bytes required to specify the path between the current device and the destination device by one. The difference between the relative port address when located within a device and while in transit between devices will be described below for FIG. 15.

A message ID (MID) nibble (4 bits) can follow the relative port address in the sideband message syntax and can be used to indicate properties of the sideband message. For example, when a messaging transaction between two devices can include multiple sideband messages, the MID can indicate the end of the messaging transaction. The message ID can also indicate whether the sideband message applies to all intermediate devices in addition to the destination device. (For example a request sideband message could indicate a power down for all network devices in the path indicated by the relative port address.) As described above, each intermediate device can update the relative port address and then forward the sideband message to the next attached network device; however, the MID can also indicate that the sideband message should be parsed for information relevant to the intermediate node in addition to forwarding the message. The MID can also identify a unique number for sideband messages within a message transaction that spans multiple sideband messages between an origination device and a destination device. As will be shown below, multiple sideband messages can be transmitted between an origination device and a destination device before a confirmation of the first transmitted sideband message is received at the origination device. Sideband messages may also arrive in a different order at the destination device than when transmitted by the origination device. In an embodiment, all sideband messages for a given messaging transaction can have the same MID, which provides a method for collecting sideband messages together for parsing. In another embodiment, the same MID can be used for a reply sideband message transmitted by a destination device as used for a corresponding request sideband message received by the destination device from an origination device. The destination device can then associate each received reply sideband message with a particular transmitted request message based on the MID. The header can end with a cyclic redundancy check (CRC) field that can provide an indication of bit errors in the header. A four bit CRC4 field is shown in FIG. 12.

The syntax for the body of a sideband message can depend on whether the sideband message is a request sideband message or a reply sideband message. The embodiment shown in FIG. 12 includes a four byte parameter (PARAM) field in a sideband request message that is not used in a sideband reply message. The sideband message body can begin with a one byte command (CMD) field that provides basic information about the body of the sideband message. The CMD field can indicate whether a one byte length (LEN) field is used in the body. The CMD field can also indicate if the sideband message consists of a “Set” type command or a “Get” type command. “Set” commands can be used to transfer data from an origination device to a destination device, such as writing values to a register in the destination device. “Set” commands can also be used to affect all devices in a path from the origination device to the destination device, such as powering down the devices in the path. “Get” commands can be used to transfer data from a destination device to an origination device, such as reading values from a register in a destination device. “Get” commands can be used to query device capabilities, device settings and “current status” properties of a destination device by an origination device before sending data messages to or retrieving data messages from the destination device.

Following the one byte command field, the sideband message syntax can include a four byte parameter (PARAM) field in request sideband messages that provide additional information about the sideband message. For example, the PARAM field can specify a particular register address at which to start reading data (“Get” command) or writing data (“Set” command) as well as the length of the data to be read or written. Other parameters such as device identifiers can also be envisioned. Following the PARAM field, a length (LEN) field can specify the number of bytes of data (DATA) that follow in the message. The body of the message can end with a second cyclic redundancy check field (CRC8), this time one byte long, that can provide an indication of bit errors in the body of the message. Summing up the maximum values for all of the fields listed in FIG. 12, a sideband message can occupy up to 48 bytes as described.

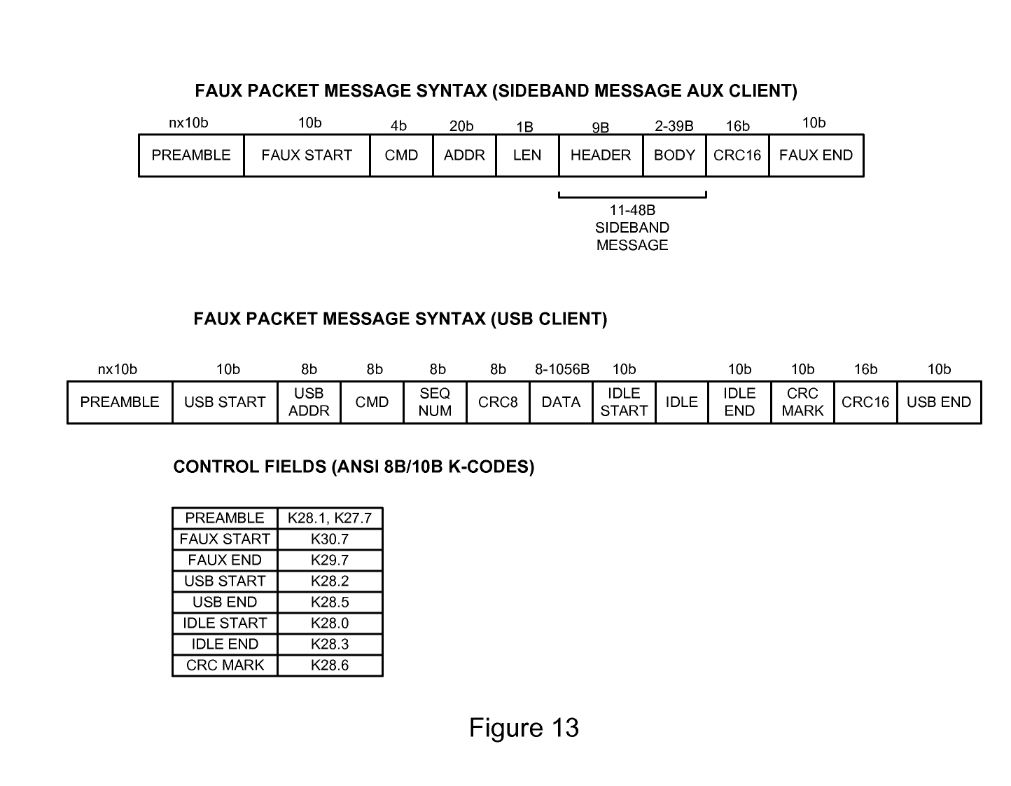

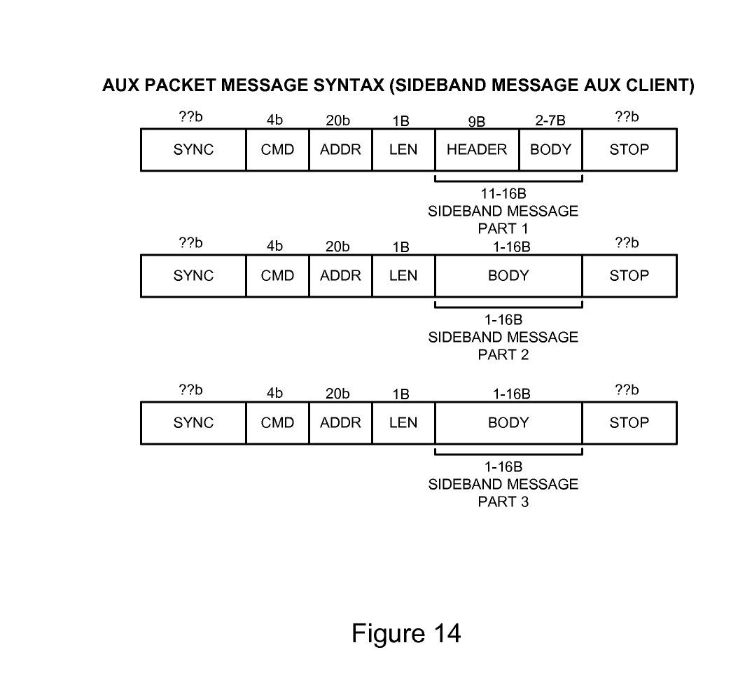

A sideband message (all 48 bytes) can be embedded in its entirety within a fast auxiliary (FAUX) channel packet message as shown in FIG. 13. As commonly used for layered communication protocols, lower layers can append additional fields about a message received from a higher layer before transport across a link. Thus a sideband message from a client services higher layer can be enveloped by fields for the link layer and physical layer of a transport protocol as shown in FIG. 13. A FAUX transport protocol's packet messages can use the same “outer” syntax for different embedded AUX channel client services' messages, sideband messages being one type of AUX client service. A different FAUX transport protocol packet message format can be used for other client services such as for a USB client service as illustrated in FIG. 13. A control field at the start and end of each FAUX transport protocol packet message (not including a preamble series of bits used for timing and synchronization) can distinguish an AUX channel client service message from a USB client service message. The control fields shown in FIG. 13 include a 10 bit FAUX START field or USB START field. The same sideband message (all 48 bytes) transported using a FAUX transport protocol can also be communicated across the bidirectional auxiliary channel using a slower AUX transport protocol. The slower rate can require splitting the sideband message into three separate parts of up to 16 bytes each as shown in FIG. 14. The AUX transport protocol's link layer can perform the separation and rejoining of the sideband message at each end of the virtual channel that links the origination device to the destination device.

FIG. 15 illustrates how several different fields in a header of a sideband message can update as a first sideband message traverses a forward path in a network from a source device 1101 to a sink device 1104, and a second sideband message traverses a reverse path from the sink device 1104 to the source device 1101. As shown in FIG. 12, the header of a sideband message can include link count total (LCT), link count remaining (LCR), relative port address (RPA) and message ID (MID) fields followed by a CRC8 field (not shown in FIG. 15). At the source device 1101 the relative path address for the sideband message consists of three forward links, port 1 of the origination source device 1101 followed by port 3 of the first branch device 1102 and ending with port 2 of the second branch device 1103. The terminating sink device 1104 has no forward port listed because that device is the destination for the sideband message. The total number of links (LCT) traversed is 3, while the number of links remaining (LCR) after leaving the originating source device 1101 is 2. Two different sideband messages are indicated in FIG. 15 by two distinct message IDs (MID=1 and 2). Note that the relative port addresses for the two sideband messages while on the link between the source device 1101 and the branch device 1102 do not contain the previous forward port (1) of the source device 1101, as that address is no longer needed to route the sideband message forward to the branch device 1102 (i.e. the sideband message is already on the required link). At the first branch device 1102, the relative port address is updated to append the reverse port 1. This added port address is the port number of the branch device 1102 in the reverse direction toward the source device 1101. It does not refer to the receiving port address 1 on the source device 1101 but rather to the sending port address of the current branch device 1102. The sideband messages with updated relative port addresses are then transported on the next link between sending port 3 of the branch device 1102 and receiving port 1 of the branch device 1103. The relative port addresses for the sideband messages while on the link again do not include the sending port number. The link count remaining is decremented by one, while the link count total remains at 3. The relative port address is updated when received at branch device 1103 to include the reverse direction port 1 from the branch device 1103 to the branch device 1102. The relative port addresses of the sideband messages while on the final link are updated (dropping the initial port number 2), while the link count remaining is decremented to 0. Upon arrival at the sink device 1104, the relative port address is updated to include the reverse direction port number 2. Thus at the source device 1101, the relative port address is 1.3.2, which describes a path to the sink device 1104, and at the sink device 1104, the relative port address is 1.1.2, which describes a path back to the source device 1101 in reverse order.

When sending a reply sideband message from the sink device 1104 to the source device 1101 in response to a received request sideband message, the sink device 1104 can derive the relative port address required for the reply sideband message by reversing the received request sideband message's relative port address. The received relative port address 1.1.2 thus becomes relative port address 2.1.1 to send the reply sideband message. Note that reply sideband messages need not be transmitted in the same time order as the request sideband messages received by the sink device 1104 nor in the same order as transmitted by the source device 1101. The link count remaining (LCR) field can be used to parse the relative port address (RPA) into a forward address and a reverse address at any device from the source device 1101 to the sink device 1104.

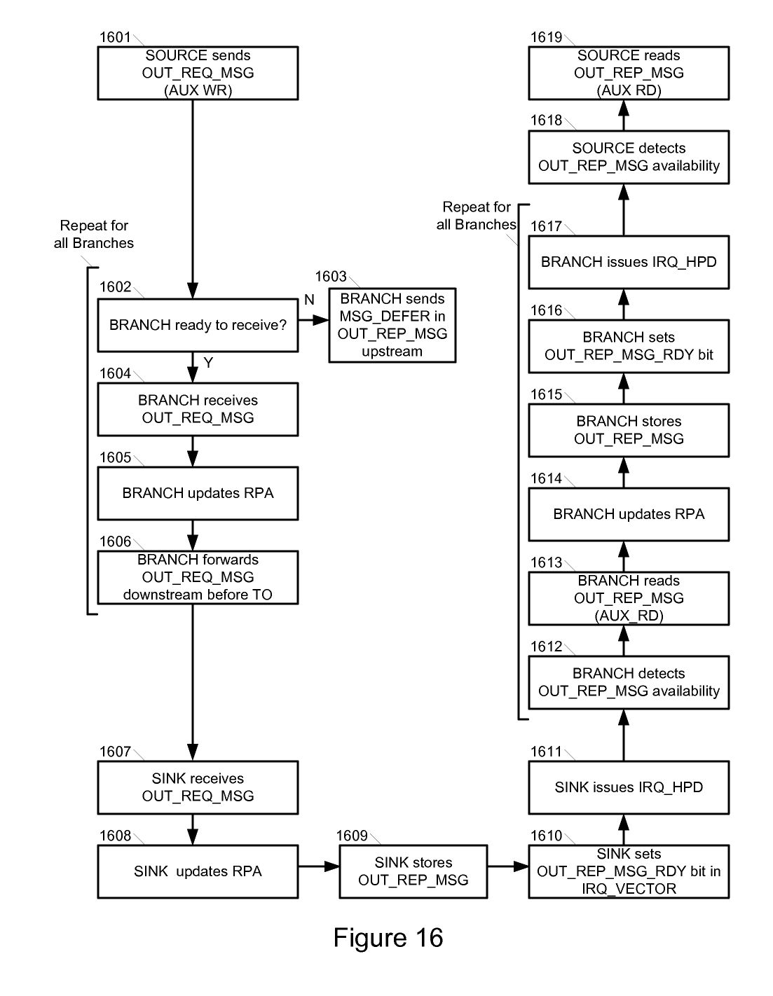

FIG. 16 illustrates a method for a complete “handshake” between a source device sending a request sideband message and a sink device sending a reply sideband message back. In step 1601 the source device sends an “outbound” request sideband message (OUT_REQ_MSG). In step 1602, each intermediate branch device determines whether it is ready to receive the request sideband message sent by the transmitting adjacent upstream device. If the branch device is ready to receive the request sideband message, then the branch device can receive the message (step 1604), update the message's relative port address (step 1605), and forward the updated request sideband message (step 1606) to the next device downstream within a given time period.

If the branch device is not ready, for example insufficient internal buffer space available to store the received request sideband message and an appropriate yet to be received reply sideband message, the branch device may respond (step 1603) to the received sideband message with a reply sideband message (OUT_REP_MSG) that defers the request sideband message. As the request sideband message has not reached its destination device, the relative port address of the request sideband message at the branch device cannot be simply reversed to indicate the path back to the origination device as was used in FIG. 15. Instead the relative port address of the received request sideband message can be parsed into two sections: (1) a relative port address for a new reply sideband message that uses the “reverse” portion of the request sideband message's relative port address in reverse order and (2) a relative port address for the remaining link from the intermediate branch device to the destination device using the “forward” portion of the received request sideband message's relative port address. As the relative port address of the reply message can be updated as the reply sideband message traverses the network back to the source device the residual “forward” portion should be stored separately, preferably in the body of the reply message.

FIG. 12 illustrates the relative port address for a sideband message sent from source device 1101 to sink device 1104 when deferred at an intermediate branch device 1102 or deferred at an intermediate branch device 1103. At branch device 1102, the sideband message's relative port address 3.2.1 separates into a relative port address for the reply sideband message, namely 1, and a relative port address for the remaining forward portion of the original request sideband message, namely 3.2. Similarly when deferring at intermediate branch device 1103, the relative port address 1.1.2 separates into a relative port address of 1.1 for the reply sideband message and an relative port address of 2 for the remaining forward portion of the request sideband message. Note that when the reply sideband message reaches the originating source device 1101, the relative port address of the reply sideband message contains the path back to the intermediate branch device that sent the deferral (in reverse order). For example, after deferring from branch device 1103, the reply sideband messages relative port address becomes 3.1 at the source device 1101. The path forward from the source device 1101 to the branch device 1103 can be represented by the relative path address 1.3 (i.e. 3.1 reversed).

Returning to FIG. 16, once the request sideband message (OUT_REQ_MSG) reaches the sink device (step 1607), the sink device can update the relative port address (1608) for a reply sideband message, which is stored locally (step 1609). The sink device then alerts the upstream attached device that it has a reply sideband message to send by setting a bit (OUT_REP_MSG_RDY) in an interrupt vector (IRQ_VECTOR) as indicated by step 1610. The sink device then issues an interrupt to the upstream attached device on the HPD signal line (step 1611). The branch device can detect the availability of the reply sideband message by either receiving the interrupt signal or by polling the interrupt vector in the sink device (step 1612). The branch device reads the reply sideband message from the sink device (step 1613), updates the relative port address (step 1614) and stores the reply sideband message with the updated relative port address (step 1615). An intermediate branch device then alerts the next attached upstream device that a reply sideband message is ready by setting an appropriate bit in its own interrupt vector register and sending an interrupt on the HPD signal line (steps 1616, 1617). The set of steps 1612 to 1617 can be repeated for each intermediate branch between the sending sink device and the final receiving source device. In step 1618, the source device detects the availability of the reply sideband message through the interrupt signal and/or through polling the status of the reply message availability bit in the interrupt vector register at the last branch device. The source device then reads the reply sideband message from the branch device (step 1619). Unlike when the request sideband message first traversed the forward path, the intermediate branch devices now need not defer a reply sideband message because they had previously allowed (and therefore were ready to receive a subsequent reply sideband message) when the corresponding request sideband message traversed through each identical intermediate branch device.

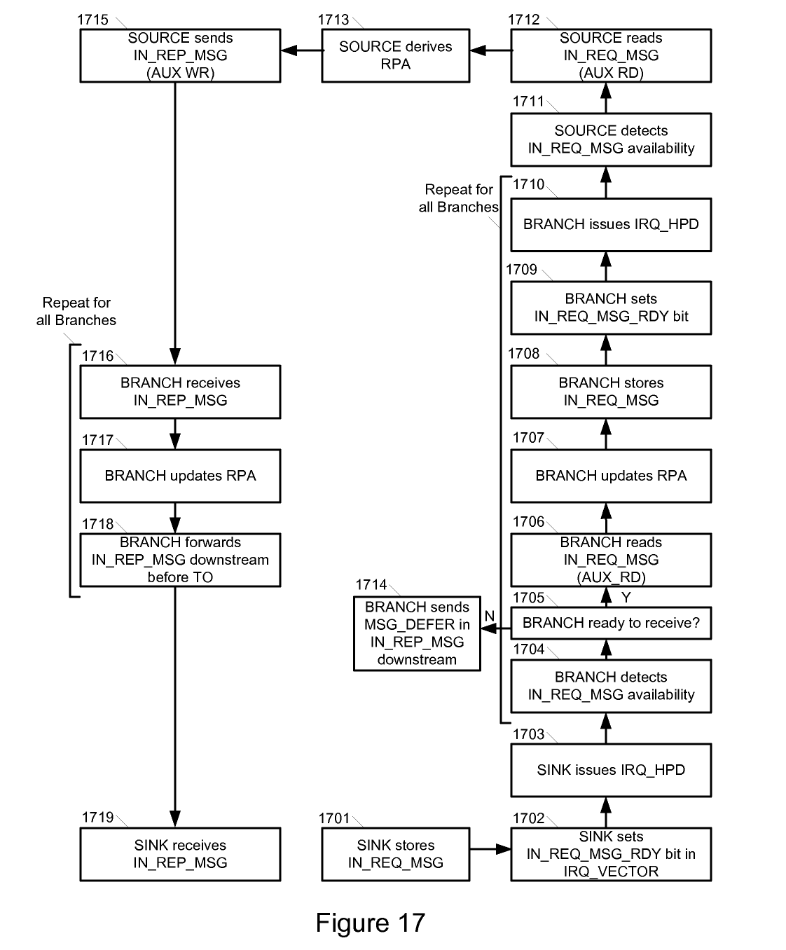

FIG. 17 illustrates a method for a complete handshake between a sink device and a source device for a request sideband message (IN_REQ_MSG) followed by a reply sideband message (IN_REP_MSG). While FIG. 16 illustrates an “OUT” message transaction from the source device starting in the downstream direction toward the sink device and ending in the upstream direction back at the source device, FIG. 17 shows the reverse “IN” message transaction starting in the upstream direction from the sink device and ending in the downstream direction. A sink device forms and stores a request sideband message (IN_REQ_MSG) for transmission upstream (step 1701). The sink device indicates to an attached upstream branch device the availability of the request sideband message by setting a bit (IN_REQ_MSG_RDY) in an interrupt vector (step 1702) and issuing an interrupt on an HPD signal line (step 1703). The branch device can detect the availability of the request sideband message by receiving the interrupt signal and by polling the interrupt vector in the sink device (step 1704). If the branch device is not ready to receive the request sideband message, then the branch device can send a reply sideband message (IN_REP_MSG) containing a message defer indication to the sink device (step 1705). The intermediate branch device can defer receipt until it has enough buffer storage for the request message and a corresponding reply message.

When the branch device is ready to receive the request sideband message, the branch device can read the stored message by sending an auxiliary channel read request to the sink device (step 1706). The branch device then updates the message's relative port address (step 1707) and stores the updated request sideband message for transmission to the next upstream networked device (step 1708). The branch device indicates to the next upstream device the availability of the request sideband message by setting a bit in the interrupt vector (step 1709) and by issuing an interrupt on the HPD signal line connected to the upstream device (step 1710). The set of steps 1704 to 1710 repeat for each intermediate branch between the sink device and the source device, until the most upstream intermediate branch device indicates to the source device the availability of the sideband request message.

The source device detects the sideband request message availability and reads the message (steps 1711/1712). Using the received sideband request message's relative port address, the source device derives a new relative port address for sending a reply sideband message (IN_REP_MSG) back to the sink device (step 1713). The source device writes the reply sideband message to the downstream branch device using an auxiliary channel write command (step 1715). The downstream branch device receives the reply sideband message (step 1716), updates the message's relative port address (step 1717) and forward the message before a timeout period expires to the next device downstream (step 1718). As the request sideband message (IN_REQ_MSG) from the sink device traversed all intermediate branch devices when proceeding upstream, and any deferrals were overcome by the eventual receipt and transmission of the request sideband message upstream, each intermediate branch device is “ready” to receive the downstream reply sideband message (IN_REP_MSG). The intermediate branch devices are thus not required to defer the reply sideband message, as the branch devices agreed to accept the corresponding previous request sideband message (and therefore indicated that they had storage space available for a subsequent reply sideband message). Finally in step 1719 the sink device receives the reply sideband message.

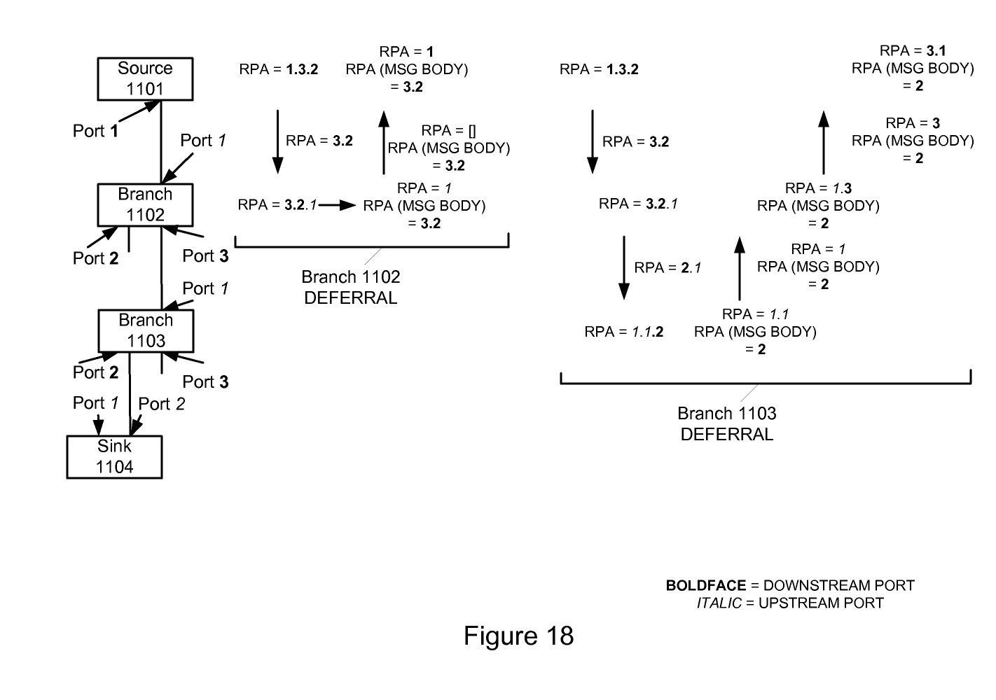

FIG. 18 illustrates how the relative port addresses of “deferral” reply sideband messages can be split into two parts to indicate (1) the return path from the origination device to the deferring branch device and (2) the forward path from the deferring branch device to the destination device. The relative port address for a request sideband message from the source device 1101 to the sink device 1104 at an intermediate branch device 1102 or 1103 consists of a forward portion (3.2 or 2) and a reverse portion (1 or 1.1). If the intermediate branch device 1102 or 1103 defers the request sideband message, then the branch device 1102 or 1103 can form a new forward relative port address for the reply sideband message from the return path. The remaining forward path can be placed in the reply sideband message body. When the reply sideband message from the deferring branch device reaches the source device, the message body contains the forward path from the deferring branch device to the sink device, while the message's relative port address contains the forward path from the source device to the deferring branch device (in reverse order).

In addition to sending deferral reply sideband messages, intermediate branch devices can also send timeout reply sideband messages if the intermediate branch device does not receive a reply sideband message from the destination device to which a corresponding request sideband message was forwarded within a calculated time period. The intermediate branch device can determine a timeout period amount based on the number of links remaining between the intermediate branch device and the destination device. Each link can have a timeout period for a request sideband message to traverse in one direction and a different timeout period for a reply sideband message to traverse in the opposite direction. The destination device can also have a further different timeout period to respond to a received request sideband message with a corresponding reply sideband message. A timeout reply sideband message from an intermediate branch device can include relative port address information from the intermediate branch device to the destination device and separately to the origination device as described above for deferral reply sideband messages. A requesting origination device can then determine the exact intermediate network device at which the time out occurred.

### Time Code Synchronization

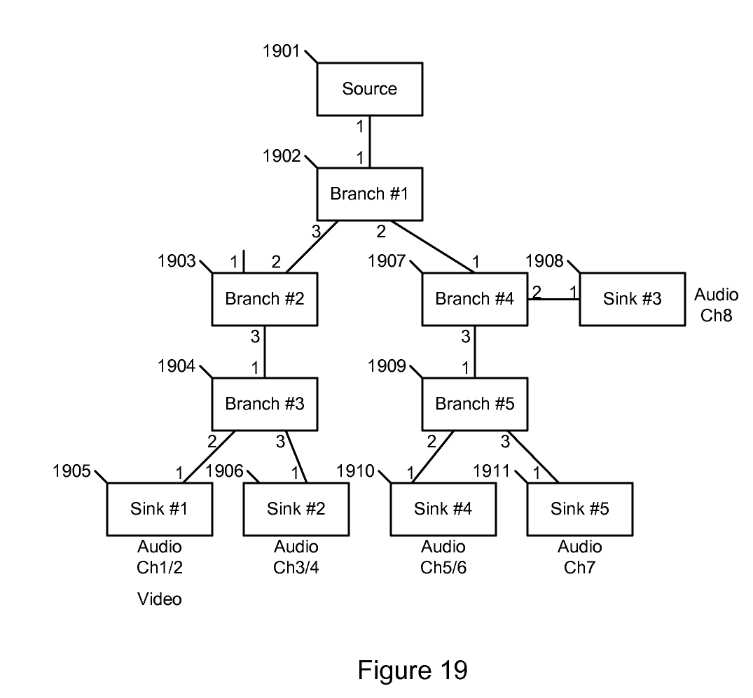

FIG. 19 illustrates an example network interconnecting a source device to multiple sink devices through one or more branch devices communicating audio and video packets between them. A source device 1901 generates packetized multimedia and data traffic and can connect to sink devices 1905, 1906, 1908, 1910, and 1911 through multiple concatenated communication links that each can support multiple streams of multimedia and data packets. For example, the source device 1901 (such as a DVD player) can generate a multiple channel audio stream that can be transported to each of the sink devices 1905, 1906, 1908, 1910, and 1911 (such as a digital speaker or a digital reproduction device driving an analog speaker) that can process and reproduce one or more channels in the multiple channel audio stream. This multiple channel audio stream can be formatted as a series of packets transported within an isochronous stream with embedded self clocking (i.e. no separate clock signal required). The stream of audio packets can be transported using one or more unidirectional physical links. A separate bidirectional stream of data packets can accompany the unidirectional audio stream on a separate physical link between the networked devices, both streams contained in the same cable.

The source device 1901 in FIG. 19 can also generate a stream of video packets that accompany the audio packets to one of the sink devices, such as sink device 1905, in the multimedia network. Thus sink device #1 1905 can represent a video display device, such as a flat screen television, that includes both video reproduction capability and a pair of speakers for reproduction of two audio channels. The other sink devices #2 to #5 1906/1908/1910/1911 can represent speakers for auxiliary audio channels, such as left/right surround channels, a center channel and a subwoofer channel. Each of these “speaker” sink devices can be located at different physical positions and connect to the source device through a different path of intermediate devices as indicated in FIG. 19. As the packetized communication links between each device in the network can be isochronous or asynchronous, local reference clocks at the several sink devices 1905, 1906, 1908, 1910, and 1911 can differ from a local reference clock at the source device 1901 and also differ from each other. This difference in local reference clocks can impede the accurate reproduction of multiple channel audio by the multiple sink devices. Preferentially the time at which each sink device reproduces an audio channel can be aligned with respect to a display of video as well as to audio reproduction at other sink devices.

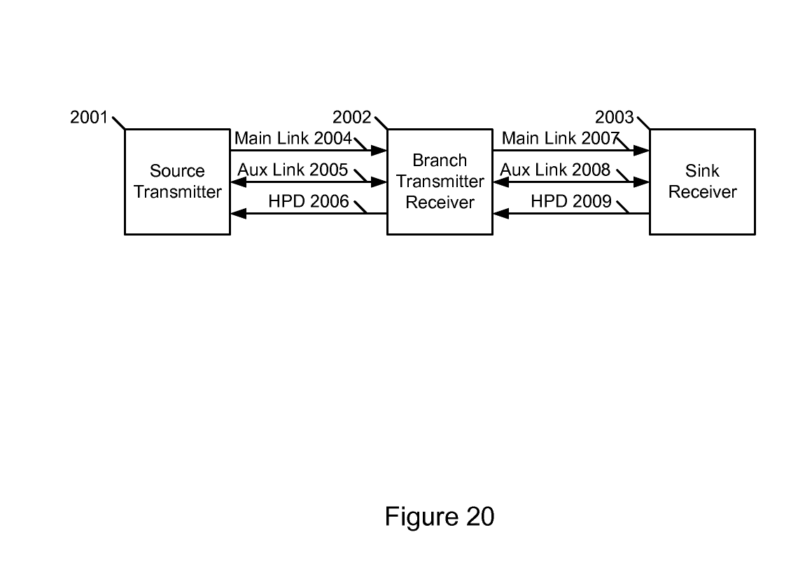

FIG. 20 illustrates a source device 2001 connected to a sink device 2003 through a branch device 2002. The connection between the source device 2001 and the branch device 2002 includes a unidirectional main link channel 2004 that can support multimedia packets, e.g. video packets and audio packets, a bidirectional auxiliary link channel 2005 that can support data packets and a unidirectional hot plug detect channel 2006 that can provide basic status or interrupt information. The branch device 2002 is connected similarly to the sink device 2003 through a communication link comprised of two unidirectional channels 2007/2009, running in opposite directions, and a bi-directional channel 2008. Notably, these communication links with multiple channels do not include a dedicated clock channel to provide clock synchronization information between any pair of devices in the multimedia network. Instead of a dedicated clock channel, a symbol timing clock can be derived at each receiving device from transitions in the received packet stream itself, both on the main link channels 2004/2007 and separately on the auxiliary link channels 2005/2008. This symbol timing clock does not provide a “relative” time reference for aligning different video packets and audio packets received by the sink device 2003 over the main link 2007 to each other, nor does the symbol timing clock provide an “absolute” time reference for video and audio packets delivered to all of the devices in the network. Some synchronization methods use time stamps to provide time references for video and audio packets at sink devices, but offer limited accuracy as described next.

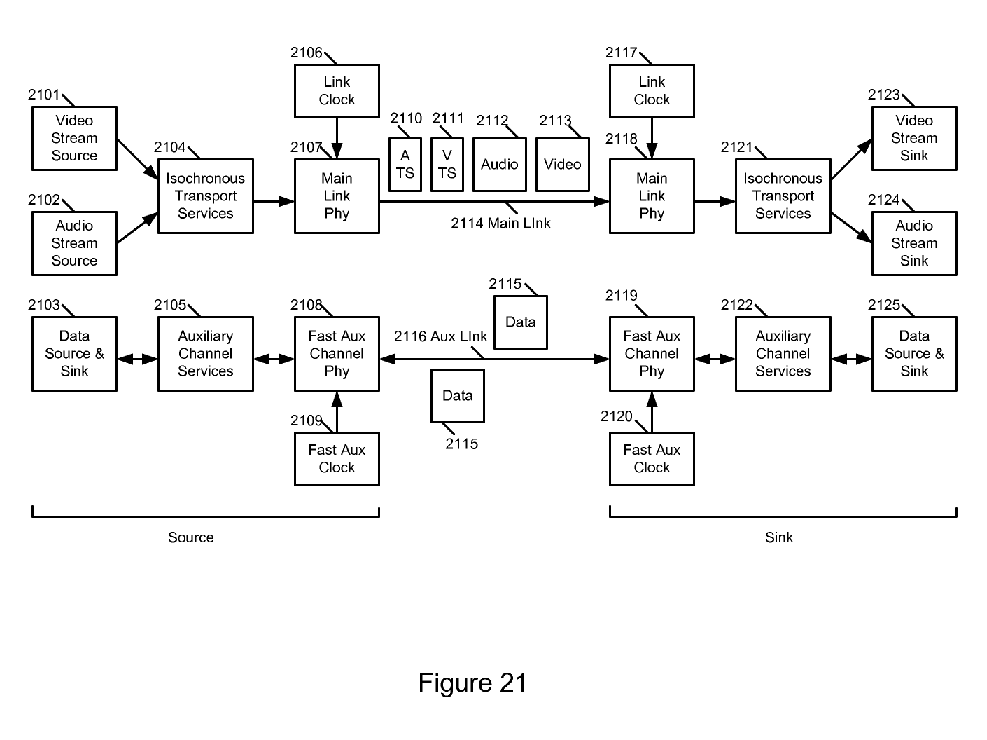

FIG. 21 illustrates processing modules in a source device and sink device that provide timing information between the networked devices. At the source end, an isochronous transport services block 2104 transforms video information provided by a video stream source 2101 into video packets 2113 and audio information provided by an audio stream source 2102 into audio packets 2112 for transport across a main link 2114. At the sink end, a parallel isochronous transport services block 2121 reconstructs the video and audio information to distribute to a video stream sink 2123 and an audio stream sink 2124 respectively. Both the video packets 2113 and the audio packets 2112 can be transported on the same main link 2114 using the same physical layer protocol. A main link physical layer transport module 2107 in the source can transmit the video packets 2113 and the audio packets 2112 using a local symbol link clock 2106. A main link physical layer transport module 2118 in the sink device can receive the video packets 2112 and audio packets 2112 using a local symbol link clock 2117. The local symbol link clock 2117 in the sink device can be adjusted based on transitions in the received stream of symbols (which include the audio and video packets) on the main link 2114; however, this adjustment does not provide a time reference by which to align the received video packets 2113 and the audio packets 2112 to each other or to an absolute time value. The video stream source 2101 and the audio stream source 2102 also can each use a different local clock to generate their respective video and audio streams and thus require different clocks at the sink device to reproduce the video and audio streams. Typically, the main link symbol timing can be independent of the video and audio source clocks.

To provide a mechanism for stream clock recovery at the sink device, time stamps can be transported along with the video and audio packets on the main link. An audio time stamp 2110 can be associated with the audio packets 2112, and a video time stamp 2113 can be associated with the video packets 2113. Each time stamp can provide information about the relationship between a clock for a stream source and the symbol link clock 2106. As the symbol link clock 2117 at the sink end can be directly related to the symbol link clock 2106 at the source end, the time stamps can be used to re-create clocks for video streams into the video stream sink 2123 and for audio streams into the audio stream sink 2125. The timing of the display of video in the video stream sink 2123 can thus be synchronized to the timing of the generation of video at the video stream source 2101. Similarly the timing of audio reproduction in the audio stream sink 2124 can be synchronized to the timing of audio generation at the audio stream source 2102. The accuracy of the timing synchronization can depend on the precision of information in the time stamp and the frequency with which the time stamp is communicated.

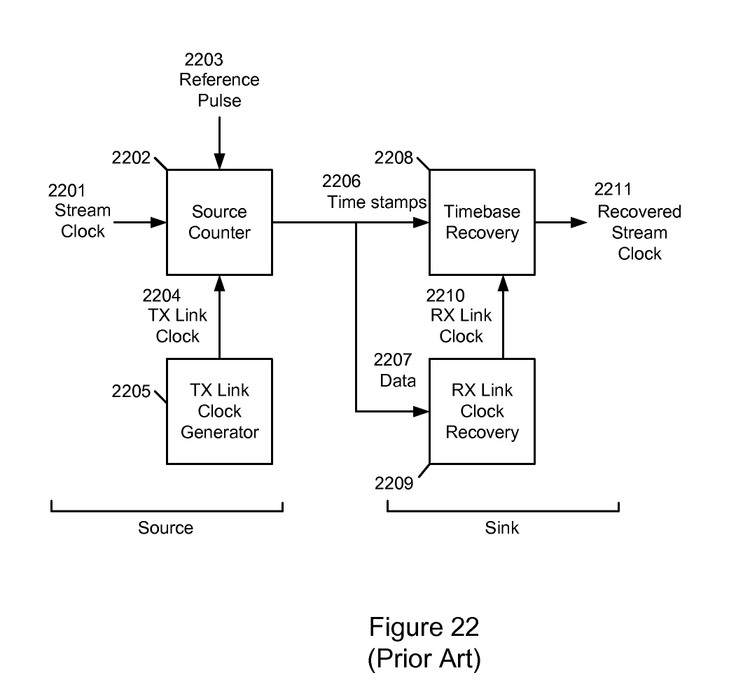

FIG. 22 illustrates a prior art method for generating and using time stamps for stream clock timing recovery. At a source end, a source counter 2202 can count the number of clock cycles in a stream clock 2201, which provides a timing reference for an incoming stream such as an audio stream or a video stream, during one period of a reference pulse 2203. During the same period of the reference pulse 2203, the source counter 2202 also can count the number of clock cycles in a transmit link clock 2204 output by a transmit link clock generator 2205 that provides a timing reference for a symbol stream, such as the video and audio packets transported on the unidirectional main link 2114 in FIG. 21. The number of clock cycles counted for each period of the reference pulse 2203 can communicated to the sink end as time stamps 2206. With sufficiently frequent transitions in a received data stream 2207 of video and audio packets, a receive link clock recovery module 2209 can generate a receive link clock 2210 that is synchronized to the transmit link clock 2204. A time base recovery module 2208 can then generate a recovered stream clock 2211 using the received time stamps 2206 and the receive link clock 2210. For example, if the transmit link clock 2204 cycles N times and the stream clock 2201 cycles M times during the reference pulse period then the recovered stream clock 2211 is directly related to the receiver link clock 2210 by the ratio M/N.

In some embodiments the reference pulse 2203 can be a fixed number of cycles (N) of the transmit link clock 2204, and as such need only be known (e.g. transmitted once during initialization) but not necessarily continuously communicated to the sink device. The M and N time stamp values can also be scaled appropriately to balance precision accuracy and jitter tolerance for a particular application (e.g. audio and video reproduction) against a bit width required for transmission. The interval between successive M and N time stamp values can affect the maximum clock skew that can occur at the sink device. The precision required to align audio at multiple sink devices can exceed the accuracy available when transmitting time stamp values relatively infrequently. Transmitting time stamps sufficiently frequently may not be feasible due limited availability of “blank” periods in which to insert the time stamps. Additionally, as illustrated by FIG. 1, a time stamp value for each sink device can traverse a different number of intervening main links, each main link adding a different amount of delay which can inhibit aligning audio reproduction at different sink devices. Rather than use the time stamps provided in the main link, a new method that provides a global time code to all devices in the network can provide a mechanism to support precise audio alignment.

In addition to the unidirectional main link 2114 that carries the audio/video packets and the time stamps discussed above, FIG. 21 illustrates a bidirectional auxiliary link 2116 between the source end and the sink end. This bidirectional auxiliary link 2116 can support data packets from multiple data sources, including a highly accurate global time code generated within a “master” source device that can be distributed to all “slave” sink devices in an interconnected multimedia network. Unlike the unidirectional main link, the bidirectional auxiliary link permits feedback messaging from “slave” sink devices to the “master” source device to determine precisely propagation delays between two different devices in the multimedia network. A different propagation delay can be determined for each sink device, thus providing a mechanism to adjust accurately a local timing reference clock at each “slave” sink device to a global timing reference clock at the “master” source device. After initializing a local timing reference accurately at a sink device, the source device can periodically send global time codes to ensure the sink device maintains synchronization to a desired accuracy for its local reference time clock.

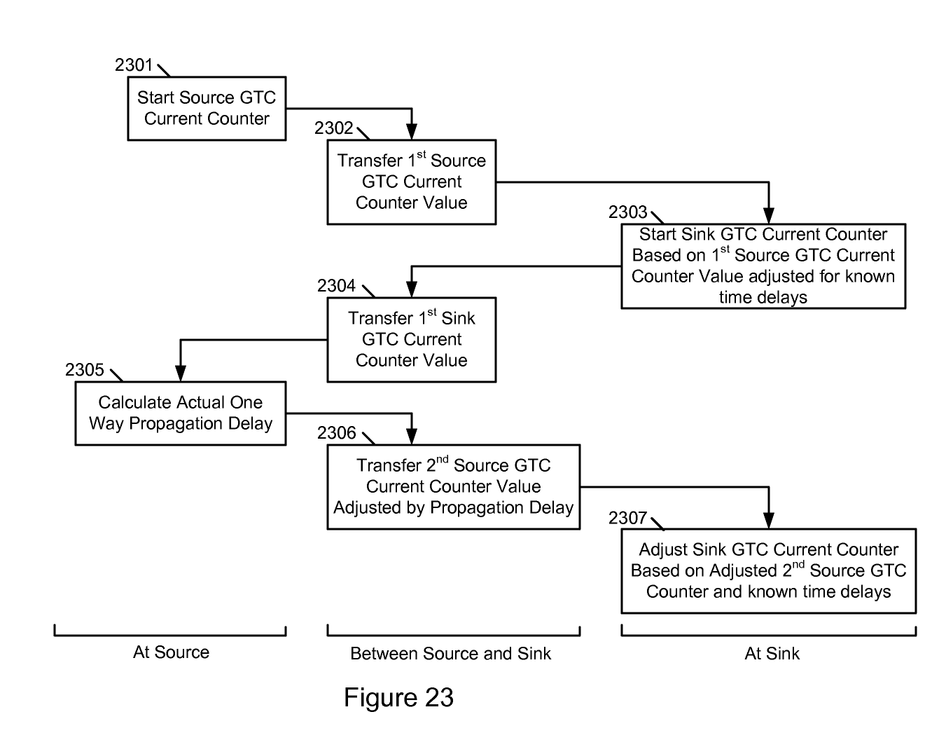

FIG. 23 illustrates a method for initial synchronization of a set of global time code (GTC) reference counters between a “master” source device and a “slave” sink device. In step 2301, the source device starts its own internal global time code “current” counter, which represents an absolute time reference at the “master” source device. This counter can be for example a 32 bit register, where each bit corresponds to 1 ns (counting cycles of a 1 GHz local reference clock). In step 2302, the source device transfers a first value of the global time code “current” counter in a packetized data message on a bidirectional auxiliary channel to a sink device. In step 2303, the sink device initializes its own internal global time code “current” counter using the value of the global time code “current” counter received from the source device. The packetized data message can include a fixed length preamble that precedes the source GTC “current” counter and can thus add a known fixed time delay. The sink device can adjust the received source GTC “current” counter by any known time delays and then use this adjusted received source GTC “current” counter value to start its own GTC “current” counter. In step 2304 the sink device can transfer the value of its own GTC “current” counter in the opposite direction on the bidirectional auxiliary channel to the source device. In step 2305 the source device receives the sink GTC current counter value and compares this value to its own source GTC current counter value to determine a propagation delay between the source device and the sink device. As performed at the sink device, this calculation can include accounting for a known delay such as incurred by using a preamble in the message that contains the sink GTC current counter value. In step 2306 the source device transfers a second source GTC current counter value to the sink device, where the value transferred is adjusted by the calculated propagation delay. The source device does not change its own local GTC current counter value (which is the “master” time reference for the entire multimedia network), but rather only adjusts the value transferred to the sink device to account for the specific propagation delay between the source device and the target sink device. In step 2307 the sink device receives the adjusted second source GTC current counter value and adjusts its own GTC current counter by the received source GTC current counter value including again any known delays (but not the propagation delay which is already contained in the received value). With this exchange of GTC current counter values between the “master” source device and the “slave” sink device and accompanying adjustments, the GTC current counter at the sink devices can be precisely aligned to the GTC current counter at the source device. As all sink devices can be aligned independently, each sink device can be adjusted for individual propagation delays between themselves and the source device. The aligned GTC current counters at the sink devices can provide a precise global time reference available locally for reproduction of received multimedia packets at that device.

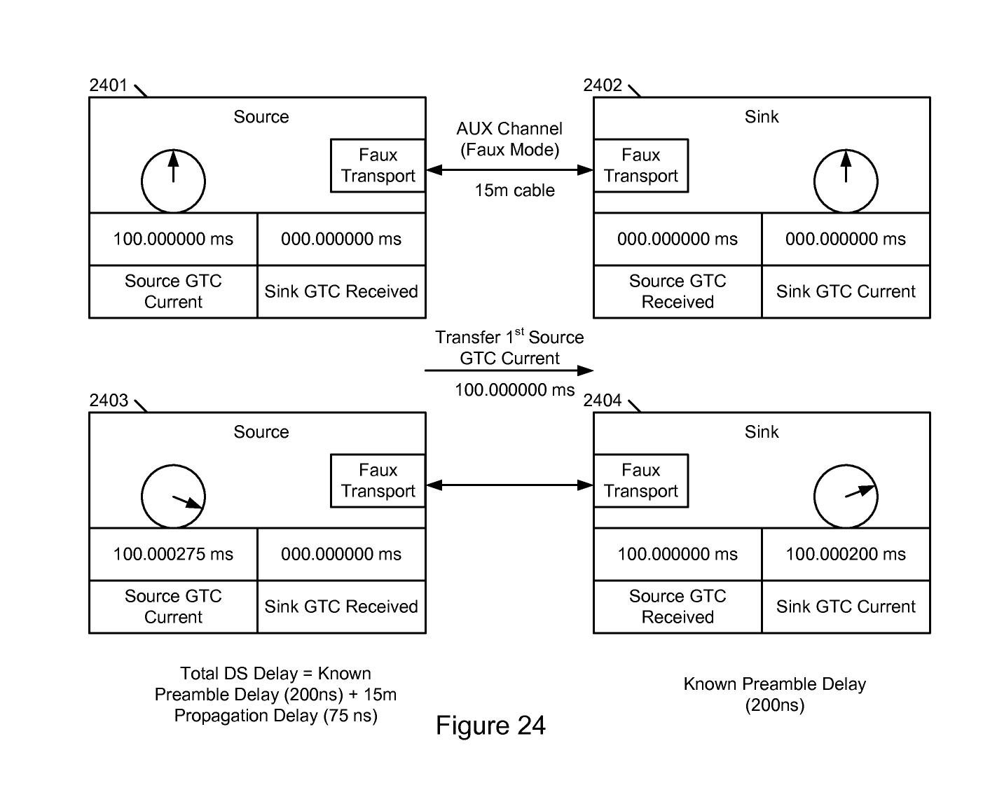

FIGS. 24, 25 and 26 illustrate an example exchange of GTC current values of the method shown in FIG. 23 between a source device and a sink device that align their values precisely. In FIG. 24, a source device and a sink device each maintain a local GTC “current” counter which advances one ns for each count of a local reference clock. As indicated by blocks 2401 and 2402, at 100 ms the source GTC current counter value of 100 ms is transmitted over an auxiliary channel to the sink device. Note that the sink GTC current counter has been initialized to 0 ms and does not advance yet. After 275 ns, as indicated by the source GTC counter value of 100.000275 ms in block 2403, the transmitted source GTC current counter value of 100 ms reaches the sink device. The downstream (DS) transmission delay between the source device and the sink device can include a known preamble delay (200 ns) and an unknown one way propagation delay (75 ns) for the 15 m of cable connecting the source device to the sink device. If the sink device connects to the source device through several intervening branch devices as shown in FIG. 19, then the total propagation delay to the sink device may be higher to account for each individual link's propagation delay. In block 2404, the sink device initializes its own local sink GTC current counter to 100.0002 ms using the received source GTC counter value of 100 ms adjusted by the known preamble delay of 200 ns. Note that the adjusted sink GTC counter value differs from the actual source GTC counter value by the unknown propagation delay of 75 ns.

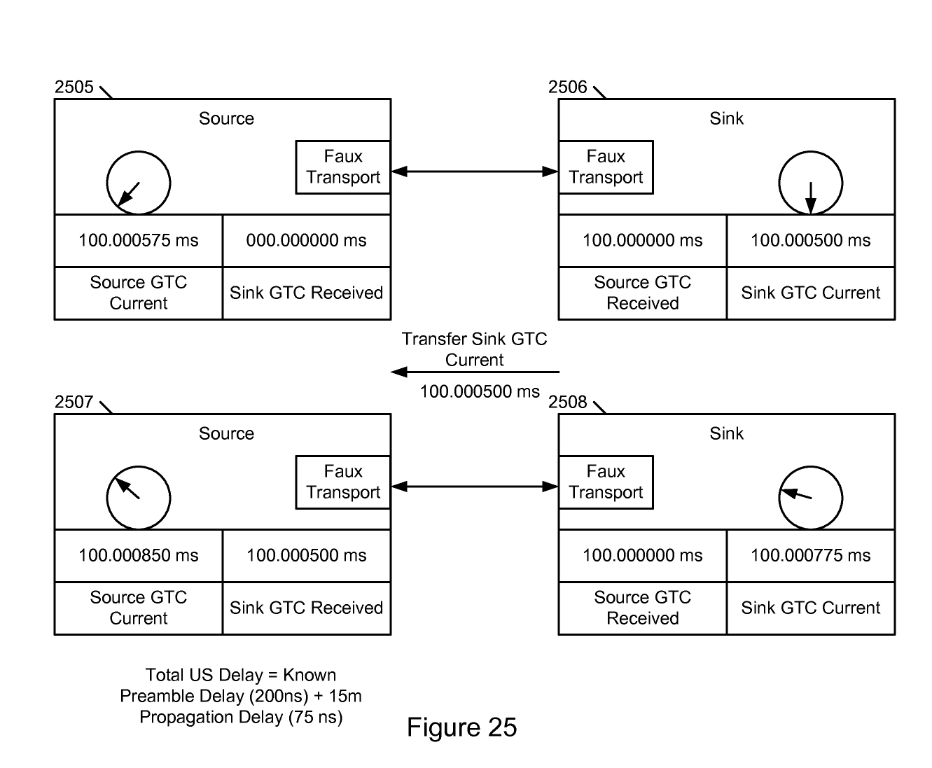

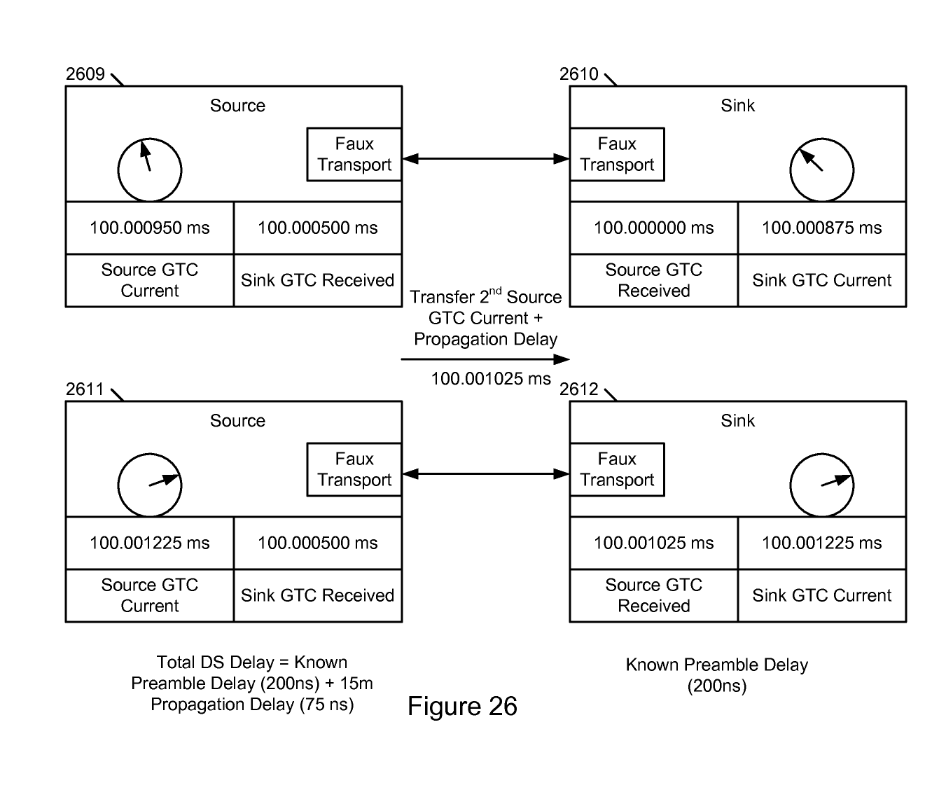

In FIG. 25, after a time elapse of 300 ns, the sink device transmits its current GTC counter value of 100.0005 ms to the source device through the bidirectional auxiliary channel. The source device receives the transmitted sink current GTC counter value after a delay that includes a known component (preamble delay of 200 ns) and an unknown component (propagation delay of 75 ns). (While the example here indicates symmetric delays, in some embodiments the known preamble delays can differ in the downstream and upstream directions respectively.) The source device can calculate the unknown one way propagation delay by comparing the current source GTC counter value of 100.00085 ms with the received current sink GTC value of 100.0005 ms. The difference in GTC counter values of 350 ns equals a known preamble delay of 200 ns plus a roundtrip propagation delay of 150 ns. As the propagation delay in both the upstream and downstream directions can be identical when the packets traverse the same path through the same set of cables, the one way propagation delay can be calculated as 150/2=75 ns. In FIG. 26, after a time elapse of 100 ns, the source device transmits its current GTC value of 100.00095 ms adjusted by the calculated one way propagation delay of 75 ns, i.e. transmits a value of 100.001025 ms. The sink device receives the source GTC value and updates its sink GTC current value to 100.001225 ms, where the received value has been adjusted by the known preamble delay of 200 ns (but not the unknown propagation delay of 75 ns which is already embedded within the received source GTC current value). The updated sink GTC current value then equals the source GTC current value, and both the source device and sink device are synchronized precisely together to a “global” time reference. The same initial synchronization method can be applied to each sink device in the multimedia network, so that all devices can be synchronized to a common “global” time reference.

After initial synchronization of the source device with each of the sink devices in the multimedia network, the local GTC counters at each device continue to increment based on transitions in their own local reference clocks. As the local reference clock frequencies at two different devices in the network can differ by as much as 1000 parts per million, any two reference clocks can diverge over time resulting in a skew of 1 us over an elapsed time period of 1 ms. This accumulated clock skew can impede the level of precision required for audio inter-channel synchronization at multiple devices. To maintain precise alignment, the “master” source device can periodically send its current GTC value to each “slave” device in the network, where each “slave” device can re-calibrate its local GTC counter with the “master” device. Unlike the initial GTC synchronization method, in which the sink device directly overwrites the sink GTC current value based on the received source GTC current value, the sink device can use instead a GTC “phase lock loop” (PLL) to update its local GTC counter based on the received source GTC values and the local sink GTC values. A fully digital or digitally controlled analog GTC PLL that adjusts the local reference clock is preferred to jam synchronizing the sink GTC counter with a free running local reference clock, as “jam syncing” cannot provide sufficiently precise control.

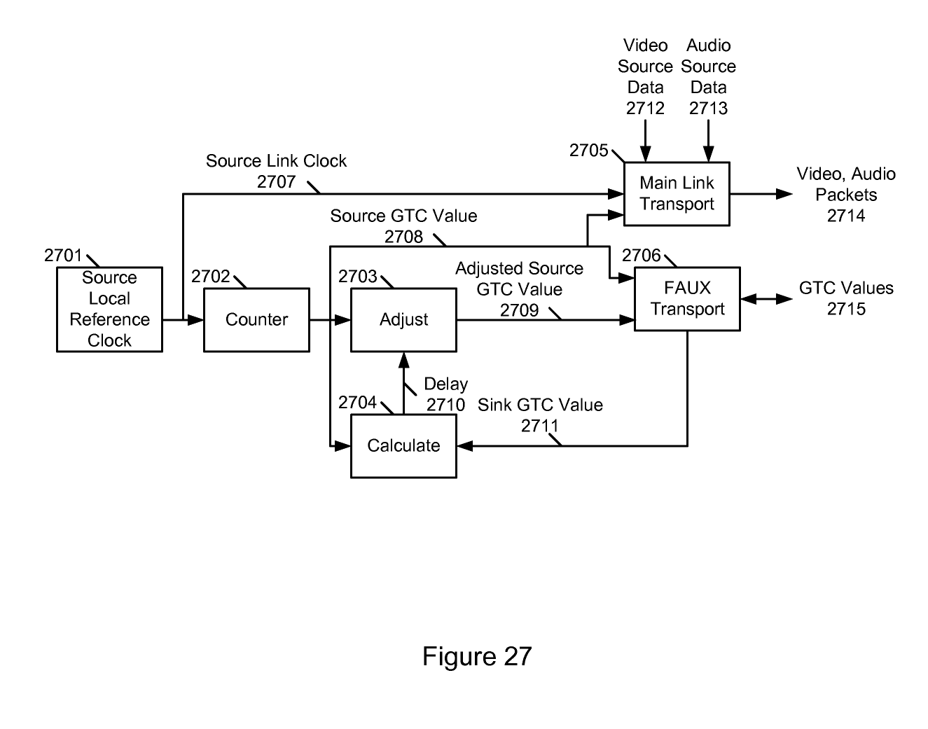

FIG. 27 illustrates an embodiment of an apparatus at a source device that can implement the time code synchronization method described in FIGS. 23 and 24-26. A source local reference clock 2701 generates a source link clock 2707 with which a main link transport module 2705 drives video and audio packets 2714 on a unidirectional main link to sink devices in a multimedia network. A counter module 2702 counts cycles of the source link clock 2707 and stores a source global time code value 708 which can be transmitted through a fast auxiliary (FAUX) transport module 2706 over a bidirectional auxiliary channel. The source GTC value 2708 can be transported without change or an adjust module 703 can generate an adjusted source GTC value 2709. As described for the method illustrated in FIG. 23, both a non-adjusted GTC value (Step 2302) and an adjusted GTC value (Step 2306) can be transferred. The FAUX transport module 2706 can receive a sink GTC value 2711 that a calculate module 2704 can use to determine a delay 2710. The delay 2710 can be used by the adjust module 2703 to generate the adjusted source GTC value 2709. After initial synchronization between the source device and the sink device, the unadjusted source GTC value can be periodically transmitted through the auxiliary channel to keep the source and sink devices synchronized.

As the source GTC value 2708 represents a “global” time code reference throughout the network, a “future” source GTC value can be transported along with audio or video packets 2714 through the main link transport to indicate an exact time at which the audio or video packets should be reproduced. As all sink devices in the network can be synchronized to the same global GTC reference, audio and video reproduction at each sink device can be thereby precisely aligned to each other by sending distinct “future” source GTC values to each sink device from the source device.

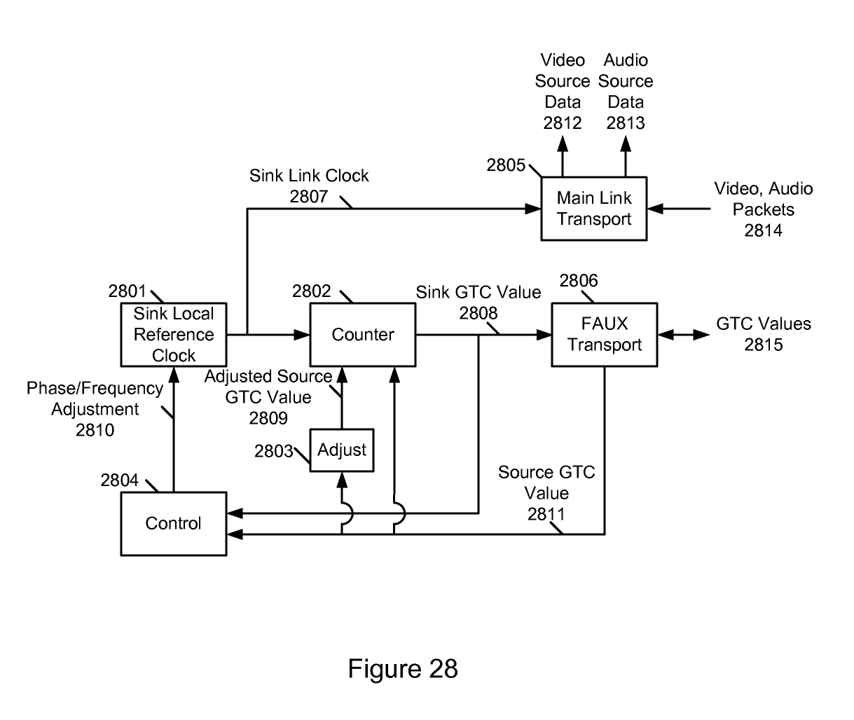

FIG. 28 illustrates an embodiment of an apparatus at a sink device that can implement the time code synchronization method described in FIGS. 23 and 24-26. A sink local reference clock 2801 can generate a sink link clock 2807 with which a main link transport module 2805 can recover video and audio source data streams 2812/2813 from received video and audio packets 2814 on a unidirectional main link from a source device. A counter module 2802 can maintain a current sink GTC value 2808 and increment the current sink GTC value based on cycles of the sink link clock 2807. A FAUX transport module 2806 can receive source GTC values 2811 from a source device over a bidirectional auxiliary channel. The counter module 2802 can update its sink GTC value 2808 based on the received source GTC value 2811 as well as by an adjusted source GTC value 2809 calculated by an adjust module 2803 from the received source GTC value 2811. The adjustment can account for known delays in the network between the source device and the sink device, such as a fixed preamble delay. The sink GTC value 2808 can also be transmitted by the FAUX transport module 2806 back upstream to the source device. A control module 2804 can compare the “steady state” sink GTC value 2808 with the received source GTC value 2811 to determine a phase and/or frequency adjustment 2810 with which to update the sink local reference clock 2801. The set of modules shown in FIG. 28 can synchronize initially and then maintain synchronization of a sink GTC counter value at the sink device that aligns precisely with a source GTC counter value.

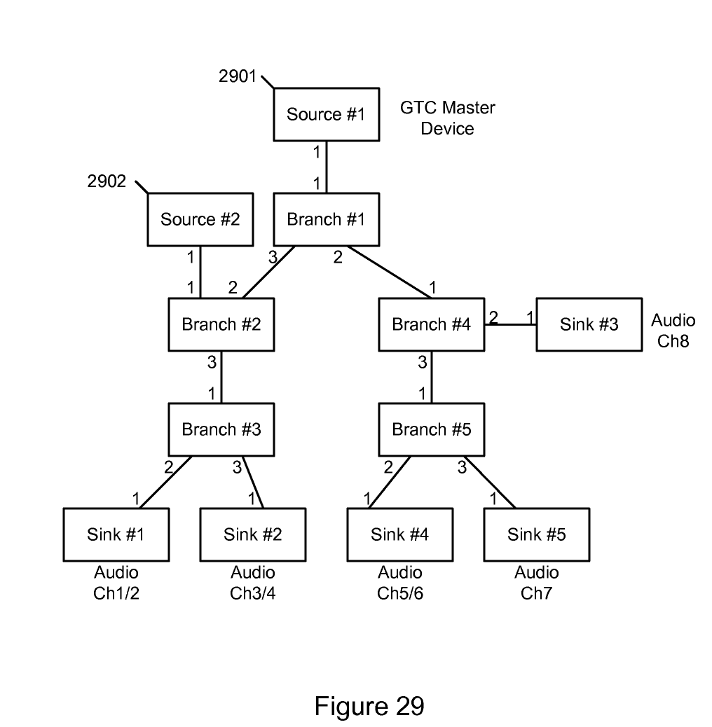

As shown in FIG. 29, a multimedia network can include multiple source devices rather than just one source device as shown in FIG. 19. Preferentially only one source device can be chosen as a “master” source device for the network's global time code. In FIG. 29, the source #1 module 2901 is shown as a GTC master device. The source #2 module 2902 can be synchronized to the GTC master device in the same manner as a sink device. After synchronizing the two source devices, both the “master” source device 2901 and the “slave” source device 902 can send “future” GTC values along with audio or video packets that indicate when their respective audio or video packets should be reproduced.

In addition, embodiments of the present invention further relate to integrated circuits and chips (including system on a chip (SOC)) and/or chip sets as well as firmware for performing the processes just described. By way of example, each of the devices described herein can include an integrated circuit chip or SOC for use in implementing the described embodiments and similar embodiments. Embodiments can also relate to computer storage products with a computer-readable medium that has computer code thereon for performing various computer-implemented operations. The media and computer code can be those specially designed and constructed for the purposes of the present invention, or they can be of the kind well known and available to those having skill in the computer software arts. Examples of tangible computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter. Computer readable media can also be computer code transmitted by a computer data signal embodied in a carrier wave and representing a sequence of instructions that are executable by a processor.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. It will be apparent to one of ordinary skill in the art that many modifications and variations are possible in view of the above teachings.

The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

What is claimed is:

1. A packet based display interface configured to operate in a multimedia device in a network, the interface comprising:
a media transport module configured to communicate video packets across a first unidirectional link;
a dual data transport module configured to communicate packet messages, in transit to or from a first sideband message handler client service module, across a bidirectional link using a first packet transport protocol or a second packet transport protocol;
a detection module configured to receive an interrupt signal on a second unidirectional link opposite in direction to the first unidirectional link; and
an event monitor client service module configured to determine the availability of a packet message from a second sideband message handler client service module across the bidirectional link based on the received interrupt signal;
wherein the first and second unidirectional links and the bidirectional link each use separate physical communication lines bundled together in a common cable.

2. In a packet based display interface, a method for communicating a packet message between a master client service module in a source device and a slave device attached to a sink device across a bidirectional link that connects the source device to the sink device in a multimedia network, the method comprising:
detecting by a first translation module in the sink device availability of a first packet message from the slave device attached to the sink device to communicate through the bidirectional link to the master device;
setting a status indication in a first client service module in the sink device indicating availability of the packet message;
transmitting the status indication of the first client service module to a second client service module in the source device in response to a status request from the second client service module;
sending a read request from a second translation module in the source device to the sink device in response to the transmitted status indication;
translating by the first translation module in the sink device the first packet message from the slave device that uses a first packet transport protocol into a second packet message formatted using a second packet transport protocol;
transmitting the second packet message from the sink device to the source device across the bidirectional link;
translating by the second translation module in the source device the received second packet message formatted using the second packet transport protocol back into the first packet message formatted using the first packet transport protocol; and
delivering the first packet message to the master client service module in the source device.

3. A packet based display interface having an apparatus in a sink device for synchronizing the sink device to a source device in a multimedia network, the apparatus comprising:
a local sink reference clock module configured to generate a sink link clock signal;
a unidirectional main link transport module configured to receive multimedia packets at a symbol rate determined by the sink link clock signal;
a counter module configured to increment a value of a sink global time code register based on the sink link clock signal;
a bidirectional auxiliary channel transport module configured to receive a source global time code value from the source device and to transmit a subsequent sink global time code value to the source device;
wherein the value of the sink global time code register in the counter module is configured to be adjusted based on the received source global time code value.
